(19) United States
(12) Patent Application Publication
(10) Pub. No.: US 2013/0038529 A1
(43) Pub. Date: Feb. 14, 2013

(54) CONTROL DEVICE AND METHOD FOR CONTROLLING SCREEN

(71) Applicants: Deng-Huei Hwang, New Taipei City (TW); Tsang-Der Ni, Hsinchu City (TW); Kwang-Sing Tone, Hsinchu City (TW)

(72) Inventors: Deng-Huei Hwang, New Taipei City (TW); Tsang-Der Ni, Hsinchu City (TW); Kwang-Sing Tone, Hsinchu City (TW)

(73) Assignee: J-MEX, INC., Hsinchu City (TW)

(21) Appl. No.: 13/570,623

(22) Filed: Aug. 9, 2012

(30) Foreign Application Priority Data
Aug. 9, 2011 (TW) 100128434

(51) Int. Cl. G06F 3/033

(52) U.S. Cl. 345/157

(57) ABSTRACT

A control device for controlling a screen includes a processing unit. The screen has a geometric reference for an operation and a first pattern associated with the geometric reference. The control device is configured to sequentially have a plurality of reference directions and an operating direction, the plurality of reference directions defines a reference direction range corresponding to the geometric reference, and the operating direction and the reference direction range have a relationship therebetween. The processing unit generates a plurality of patterns associated with the first pattern in the plurality of reference directions, respectively, estimates the reference direction range according to the plurality of reference directions and the plurality of patterns, and controls the operation of the screen by estimating the relationship.

### CROSS-REFERENCES TO RELATED APPLICATIONS

This application claims the benefit of Taiwan Patent Application No. 100128434, filed on Aug. 9, 2011, in the Taiwan Intellectual Property Office, the disclosures of which are incorporated herein in their entirety by reference.

### FIELD OF THE INVENTION

The present invention relates to a control device and method for controlling a screen, and more particularly to a control device and method for controlling a screen by motion sensing.

### BACKGROUND OF THE INVENTION

At present, the varieties of the three-dimensional (3D) air mouse devices working on the personal computer (PC) platform are generally using the communication interface unit and driving program adopted by the existed two-dimension (2D) mouse device. The current on-plane 2D mouse device controls the cursor to move by means of sensing the plane motion distance through a mechanical and/or optical means; in contrast, the 3D air mouse device drives the cursor by means of sensing a 3D motion of the device in the air during operation. However, except the different sensing means, the cursor operation characteristics of the 3D air mouse device is in itself still similar to those of the on-plane mouse device controlled through the PC, thus the 3D air mouse is unavoidably to inherit the operation drawback from the 2D mouse, which degenerates the convenient and nimble operation of cursor moving on the screen to be achieved by the 3D air mouse. Such as, when the cursor moves to a boundary area of the display area of the screen, the cursor on the boundary is no longer to moves to cross the boundary even though a further motion is applied by the 2D mouse. Similarly, the 3D air mouse device or the 3D motion sensing remote controller also have the same drawback described above as the traditional 2D mouse, and causes a problem the pointing direction of the subsequent posture orientation of the remote controller or the air mouse is inconsistent with the cursor position as the cursor on the boundary making no response to a further motion or an orientation changing of the controller or device, and thus causes the operation perplexity that the user posture orientation cannot be aligned with the cursor.

Though on the game platform of the Nintendo Company, the Wii game remote controller employs an image sensor to sense two light emitting diodes to operate the remote controller in a confined range for controlling the cursor movement in a specific range on the screen, the above-mentioned disadvantage occurring on the PC platform still exists in the Wii game device; i.e. the orientation of the remote controller cannot keep being aligned with the cursor especially after the operation of applying the controller a further motion to move the cursor on the boundary. A related technical scheme in the prior art is disclosed in U.S. Patent Application Publication No. 2010/0292007 A1 provides systems and methods for a control device including a movement detector.

It is considered the condition that: a handheld motion-sensing remote controller is operated to select items of the electronic menu on the screen, or a 3D air mouse device is controlled to move a cursor and conduct a click for selecting an icon. Please refer to FIG. 1(a), FIG. 1(b) and FIG. 1(c), which are schematic diagrams showing a first operation, a second operation and a third operation of a motion remote-control system 10 in the prior art, respectively. As shown in FIG. 1(a), FIG. 1(b) and FIG. 1(c), the motion remote-control system 10 includes a remote-control device 11 and a screen 12. The screen 12 has a display area 121, which has a perimeter 1211; and a cursor H11 is displayed in the display area 121. The remote-control device 11 may be one of a motion-sensing remote controller and a 3D air mouse device.

For instance, as shown in FIG. 1(a), the cursor H11 is controlled to move in the horizontal direction. In a state E111, the remote-control device 11 has an orientation N111, and the orientation N111 with an alignment direction V111 is aligned with the cursor H11. In a state E112, the remote-control device 11 has an orientation N112, and the orientation N112 with an alignment direction V112 is aligned with the cursor H11. The posture or the orientation of the remote-control device 11 in the air points to a variable direction; and ideally, the variable direction is to be aligned with the cursor H11 moved on the screen, so that the user can intuitively consider being consistent with the direction, indicating where the cursor H11 is located, when operating the cursor movement by the gesture or the motion of his/her hand (not shown).

However, the first operation shown in FIG. 1(a) can perplex the operation of the 3D air mouse. FIG. 1(b) shows how the perplexity is happing during operation. In a state E121, the remote-control device 11 has an orientation N121 with an alignment direction V121 aligned with the cursor H11. In a state E122, the remote-control device 11 has an orientation N122 with an alignment direction V122 aligned with a position P11 outside the display area 121. For instance, in the state E121, the cursor H11 touches a boundary of the perimeter 1211 of the display area 121. Afterward, if the remote-control device 11 further has a motion or a posture change, the orientation of the remote-control device 11 will only be changed from the orientation N121 into the orientation N122, and the pointing direction of the remote-control device 11 will be correspondingly changed from the alignment direction V121, originally pointing to the cursor H11, into the alignment direction V122, but the remote-control device 11 cannot cause the cursor H11 to further cross over the perimeter 1211, and thus a deviation or a misalignment between the device's orientation and its direction pointing at the cursor H11 is happened.

Under this condition, the second operation shown in FIG. 1(b) will result in the phenomenon shown in FIG. 1(c). In a state E131, the remote-control device 11 has an orientation N131, and the orientation N131 with the alignment direction V131 is aligned with a position P12 outside the display area 121. When the remote-control device 11 is moved back to control the cursor H11 to simultaneously move back away from the boundary, the remote-control device 11 has the orientation N131, which is aligned with the position P12, and the pointing direction of the remote-control device 11 cannot be caused to point to the alignment direction V132 for being aligned with the cursor H11 in the display area 121. In this way, the remote-control device 11 cannot be recovered to have the orientation or the posture, which the remote-control device 11 previously has under the normal operation in the state that the cursor H11 has not touched the perimeter 1211, thereby forming an orientation deviation. The orientation deviation causes that the remote-control device 11 cannot have the alignment direction V132 to be aligned with the cursor H11 in the orientation N131 for intuitively controlling the motion of the cursor H11. Therefore, the inconsistence between the alignment direction of the orientation of the remote-control device 11 and the actual direction pointing to the cursor causes the perplexity when the user operates.

### SUMMARY OF THE INVENTION

It is therefore an object of the present invention to provide a control device and method for controlling a screen. One of a motion-sensing remote controller and an air mouse device will go back to the original posture or the original orientation to continue to click on an electronic item or control the cursor to move on the screen whether the cursor touches the boundary area of the screen or not.

It is an embodiment of the present invention to provide a control device for controlling a screen. The screen has a geometric reference for an operation and a first pattern associated with the geometric reference. The control device is configured to sequentially have a plurality of reference directions and an operating direction, the plurality of reference directions defines a reference direction range corresponding to the geometric reference, and the operating direction and the reference direction range have a relationship therebetween. The control device includes a processing unit. The processing unit generates a plurality of patterns associated with the first pattern in the plurality of reference directions, respectively, estimates the reference direction range according to the plurality of reference directions and the plurality of patterns, and controls the operation of the screen by estimating the relationship.

It is a further embodiment of the present invention to provide a method for controlling a screen having a geometric reference for an operation. The method includes the following steps. A first pattern associated with the geometric reference is displayed on the screen. A plurality of reference directions is provided, wherein the plurality of reference directions define a reference direction range corresponding to the geometric reference. A plurality of patterns associated with the first pattern is generated in the plurality of reference directions, respectively. The reference direction range is estimated according to the plurality of reference directions and the plurality of patterns for controlling the operation of the screen.

It is a further embodiment of the present invention to provide a control device for controlling a screen. The screen has a geometric reference for an operation and a first pattern associated with the geometric reference. The control device is configured to have a plurality of reference directions, and the plurality of reference directions defines a reference direction range. The control device includes a processing unit. The processing unit generates a plurality of patterns associated with the first pattern in the plurality of reference directions, respectively, and estimates the reference direction range according to the plurality of reference directions and the plurality of patterns for controlling the operation of the screen.

### BRIEF DESCRIPTION OF THE DRAWINGS

The foregoing and other features and advantages of the present invention will be more clearly understood through the following descriptions with reference to the drawings, wherein:

FIG. 1(a), FIG. 1(b) and FIG. 1(c) are schematic diagrams showing a first operation, a second operation and a third operation of a motion remote-control system in the prior art, respectively;

FIG. 2 is a schematic diagram showing a control system according to the first embodiment of the present invention;

FIG. 3(a), FIG. 3(b) and FIG. 3(c) are schematic diagrams showing three configurations of a control system according to the second embodiment of the present invention, respectively;

FIG. 4(a), FIG. 4(b), FIG. 4(c) and FIG. 4(d) are schematic diagrams showing four pattern models of the control system according to the second embodiment of the present invention, respectively;

FIG. 5 is a schematic diagram showing a control system according to the third embodiment of the present invention;

FIG. 6(a) and FIG. 6(b) are schematic diagrams showing a first configuration and a second configuration of a control system according to the third embodiment of the present invention, respectively;

FIG. 7(a) and FIG. 7(b) are schematic diagrams showing a third configuration and a fourth configuration of the control system according to the third embodiment of the present invention, respectively; and

FIG. 8(a), FIG. 8(b), FIG. 8(c), FIG. 8(d) and FIG. 8(e) are schematic diagrams showing five pattern models of the control system according to the third embodiment of the present invention, respectively.

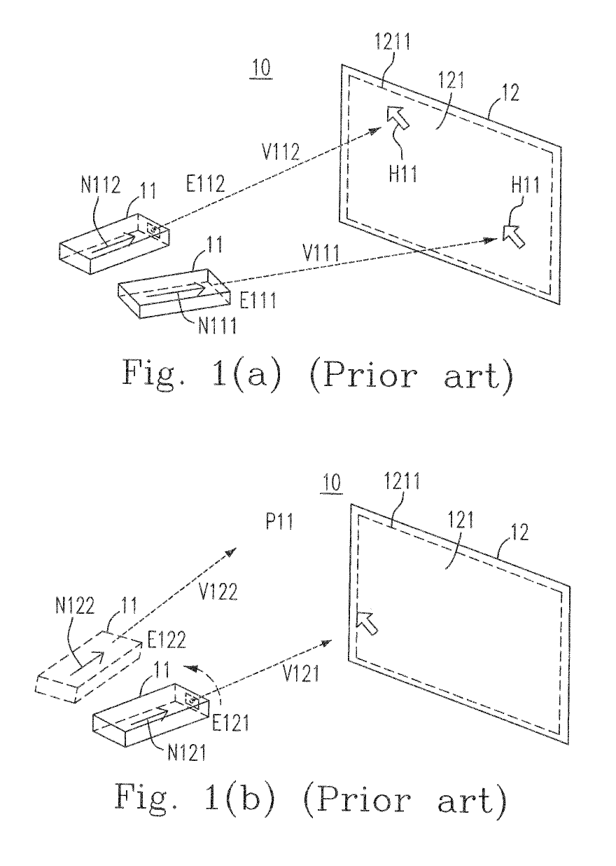

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

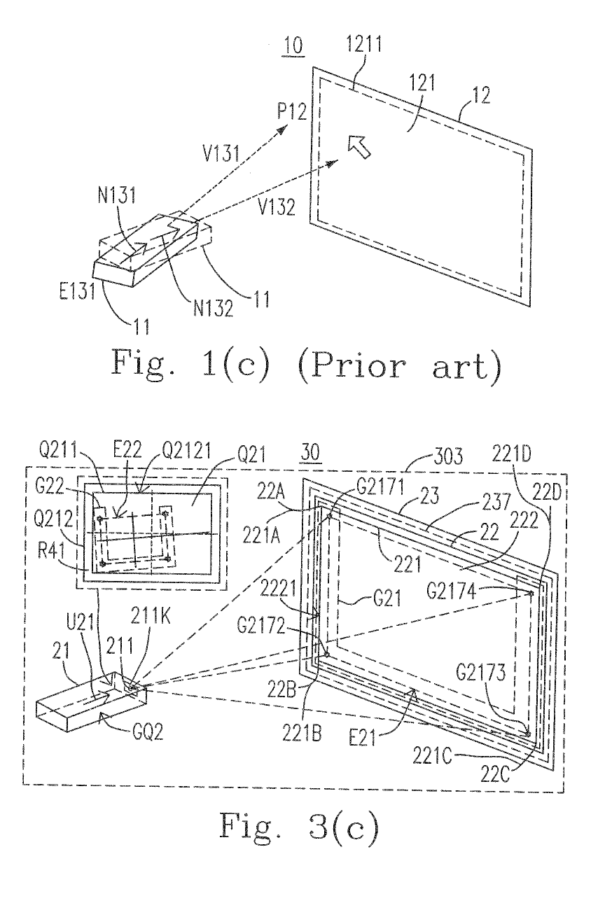

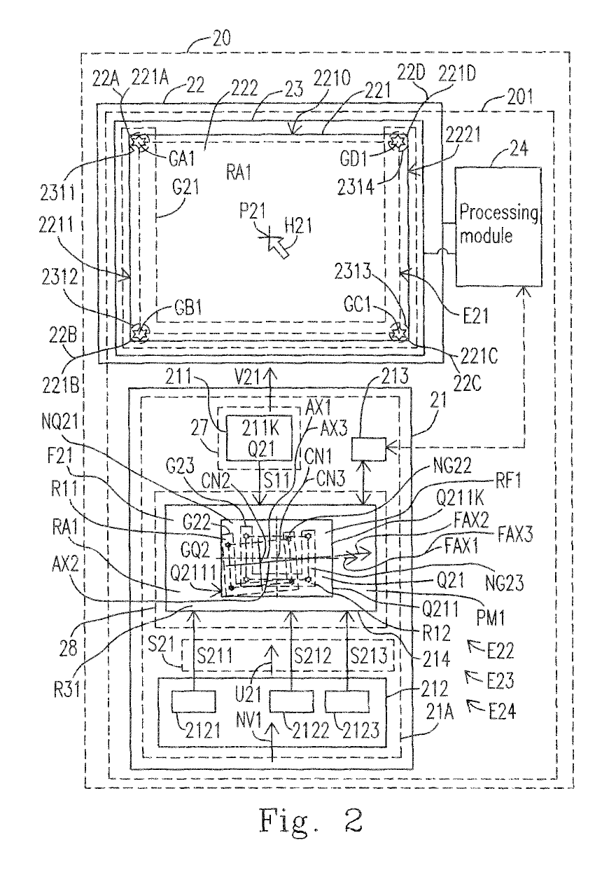

Please refer to FIG. 2, which is a schematic diagram showing a control system 20 according to the first embodiment of the present invention. As shown, the control system 20 includes a screen 22 and a control system 201 for controlling an operation B1 of the screen 22. In one embodiment, the screen 22 has a geometric reference 221. The control system 201 includes a marking device 23 and a remote-control device 21. The marking device 23 displays a pattern G21 associated with the geometric reference 221 on the screen 22. The remote-control device 21 obtains a signal S11 from the screen 22. The signal S11 represents an image Q21 having a geometric reference Q211 and a pattern G22 associated with the pattern G21. The pattern G22 and the geometric reference Q211 have a geometric relationship R11 therebetween. The remote-control device 21 uses the geometric relationship R11 to transform the pattern G22 into a pattern G23, and calibrates the geometric reference 221 according to the pattern G23 for controlling the operation B1 of the screen 22.

In one embodiment, the screen 22 further has an operation area 222. The operation area 222 is a display area or a matrix display area. For instance, the operation area 222 has a characteristic rectangle, which has an upper left corner point 22A, a lower left corner point 22B, a lower right corner point 22C and an upper right corner point 22D. The geometric reference 221 is configured to identify the operation area 222. For instance, the geometric reference 221 has a reference rectangle 2211; the reference rectangle 2211 has a reference area 2210 for identifying the operation area 222, and has four reference positions 221A, 221B, 221C and 221D; and the four reference positions 221A, 221B, 221C and 221D are located at the upper left corner point 22A, the lower left corner point 22B, the lower right corner point 22C and the upper right corner point 22D of the operation area 222, respectively. A shape of the geometric reference Q211 of the image Q21 corresponds to a shape of the geometric reference 221. For instance, the geometric reference Q211 has a characteristic rectangle Q2111. For instance, the geometric reference Q211 is fixed, and is configured to define a reference area of the image Q21.

For instance, the pattern G21 has a characteristic rectangle E21. For instance, the pattern G21 and the geometric reference 221 may have a geometric relationship RA1 therebetween, and the pattern G23 and the geometric reference Q211 have a geometric relationship R12 therebetween. The remote-control device 21 obtains the geometric relationship R11, and may transform the pattern G23 into a geometric reference GQ2 according to the geometric relationships RA1 and R12 for calibrating the geometric reference 221.

In one embodiment, the remote-control device 21 has an orientation NV1, which has a reference direction U21. The remote-control device 21 obtains the signal S11 from the screen 22 in the reference direction U21, and further obtains an estimated direction F21 for estimating the reference direction U21. For instance, the remote-control device 21 senses the pattern G21 to obtain the signal S11 in the reference direction U21, and further senses the reference direction U21 to obtain the estimated direction F21 of the remote-control device 21 in the reference direction U21. The geometric reference 221 may be configured to identify the operation area 222, which includes a predetermined position P21. The remote-control device 21 obtains the geometric reference GQ2 for calibrating the geometric reference 221 according to the geometric relationship R11, thereby correlating the reference direction U21 with the predetermined position P21. The estimated direction F21 may be configured to express the alignment direction V21 aligned with the predetermined position P21 in the reference direction U21. The estimated direction F21 may be a reference-estimated direction, and the predetermined position P21 may be a reference position. For instance, the operation area 222 has a cursor H21 located thereon; and the predetermined position P21 is located in the center portion of the operation area 222, and serves as a starting reference point of the cursor H21. The remote-control device 21 causes the cursor H21 to be located at the predetermined position P21 in the reference direction U21. In one embodiment, the remote-control device 21 correlates the reference direction U21 with the predetermined position P21 according to the geometric relationship R11 and the estimated direction F21.

In one embodiment, the geometric reference Q211 has a reference rectangle Q2111, which has a shape center CN1 and a shape principal axis AX1. The pattern G22 has a characteristic rectangle E22 corresponding to the characteristic rectangle E21, wherein the characteristic rectangle E22 has a shape center CN2 and a shape principal axis AX2. The pattern G23 has a characteristic rectangle E23 corresponding to the characteristic rectangle E21, wherein the characteristic rectangle E23 has a shape center CN3 and a shape principal axis AX3. The pattern G22 and the geometric reference Q211 have the geometric relationship R11 therebetween. The geometric relationship R11 includes a position relationship between the shape center CN1 and the shape center CN2, and a direction relationship between the shape principal axis AX1 and the shape principal axis AX2. For instance, each of the shape centers CN1, CN2 and CN3 is a respective geometric center, and each of the shape principal axis AX1 is a respective geometric principal axis.

The remote-control device 21 obtains a transformation parameter PM1 according to the geometric relationship R11, and transforms the pattern G22 into the pattern G23 according to the transformation parameter PM1, wherein the transformation parameter PM1 includes a displacement parameter associated with the position relationship, and a rotation parameter associated with the direction relationship. The pattern G23 and the geometric reference Q211 have the geometric relationship R12 therebetween. The geometric relationship R12 includes a first relationship and a second relationship, wherein the first relationship is that the shape center CN1 coincides with the shape center CN3, and the second relationship is that the shape principal axis AX1 is aligned with the shape principal axis AX3.

In one embodiment, the marking device 23 displays a digital content in the operation area 222 for displaying the pattern G21 by using a program. The pattern G21 may flicker at a specific frequency, and may also includes at least a light-emitting geometric pattern. For instance, the pattern G21 may be collocated with the digital content to flicker at the specific frequency for definitely distinguishing the pattern G21 from the external noise or the background light (the background noise). The screen 22 has the geometric reference 221 for the operation B1. The remote-control device 21 may control a change of the specific frequency according to a change of the operation B1.

In one embodiment, the pattern G21 includes four sub-patterns GA1, GB1, GC1 and GD1. The four sub-patterns GA1, GB1, GC1 and GD1 are four light-emitting marks or four light-emitting spots, respectively, and are distributed near the four corner points 22A, 22B, 22C and 22D of the operation area 222, respectively. In one embodiment, the marking device 23 includes four light-source devices 2311, 2312, 2313 and 2314. The four light-source devices 2311, 2312, 2313 and 2314 generate the sub-patterns GA1, GB1, GC1 and GD1, respectively.

In one embodiment, the operation area 222 has a first resolution. The geometric reference Q211 is configured to define an area Q211K, which has a second resolution provided by the image Q21. The remote-control device 21 correlates the pattern G23 with the geometric reference 221 by using the first and the second resolutions. For instance, the operation area 222 has a first image, and the first resolution is a resolution of the first image. According to the first and the second resolutions, dimensions of the pattern G23 are correlated with dimensions of the pattern G21, respectively, or correlated with dimensions of the geometric reference 221, respectively. In one embodiment, the pattern G23 and the operation area 222 have a first dimension and a second dimension corresponding to the first dimension, respectively; and the remote-control device 21 obtains a first scale relationship between the first and the second dimensions, and transforms the operation area 222 into the geometric reference GQ2 according to the first scale relationship and the pattern G23.

In one embodiment, the pattern G23 and the operation area 222 further have a third dimension independent of the first dimension and a fourth dimension, corresponding to the third dimension, independent of the second dimension, respectively; and the remote-control device 21 further obtains a second scale relationship between the third and the fourth dimensions, and transforms the operation area 222 into the geometric reference GQ2 according to the pattern G23 and the first and the second scale relationships.

In one embodiment, the remote-control device 21 includes a processing unit 21A, which includes an image-sensing unit 211, a motion-sensing unit 212, a communication interface unit 213 and a control unit 214. The image-sensing unit 211 has an image-sensing area 211K, and senses the pattern G21 to generate the signal S11 from the screen 22 through the image-sensing area 211K. The image-sensing unit 211 transmits the signal S11 to the control unit 214 to cause the control unit 214 to have the image Q21. The motion-sensing unit 212 generates a signal S21 in the reference direction U21, wherein the signal S21 may include sub-signals S211, S212 and S213.

The control unit 214 is coupled to the image-sensing unit 211, the motion-sensing unit 212 and the communication interface unit 213, receives the signal S11, arranges a geometric relationship R31 between the geometric reference Q211 and the image-sensing area 211K, obtains the geometric relationship R11 according to the signal S11, transforms the pattern G22 into the pattern G23 according to the geometric relationship R11, obtains the geometric reference GQ2 according to the pattern G23 to calibrate the geometric reference 221, and correlates the reference direction U21 with the predetermined position P21 according to the geometric reference GQ2 and the signal S21. The communication interface unit 213 is coupled to the control unit 214, wherein the control unit 214 controls the operation B1 of the screen 22 through the communication interface unit 213. For instance, the geometric references Q211 and GQ2 may be concentric or eccentric.

For instance, the remote-control device 21 is pointed to the predetermined position P21 to have the reference direction U21, and uses the control unit 214 to cause the cursor H21 to be located at the predetermined position P21 in the reference direction U21. For instance, the control unit 214 may further obtains a geometric relationship RA1 between the pattern G21 and the geometric reference 221, and obtains the geometric reference GQ2 according to the geometric relationship RA1 and the pattern G23.

For instance, the sub-patterns GA1, GB1, GC1 and GD1 of the pattern G21 are located near the four reference positions 221A, 221B, 221C and 221D of the geometric reference 221 (or the four corner points 22A, 22B, 22C and 22D of the operation area 222), respectively. The image-sensing unit 211 senses the sub-patterns GA1, GB1, GC1 and GD1 to generate the signal S11. The control unit 214 may directly define a perimeter 2221 (having a characteristic rectangle) and the corner points 22A, 22B, 22C and 22D of the operation area 222 through calculations. In one embodiment, the motion-sensing unit 212 includes a gyroscope 2121, an accelerometer 2122 and an electronic compass 2123. The signal S21 includes the sub-signals S211, S212 and S213. The gyroscope 2121 senses a speed of the remote-control device 21 in the reference direction U21 to generate the sub-signals S211. The accelerometer 2122 senses an acceleration and/or a pitch angle of the remote-control device 21 in the reference direction U21 to generate the sub-signals S212. The electronic compass 2123 senses a direction or an angular position of the remote-control device 21 in the reference direction U21 to generate the sub-signals S213.

In one embodiment, the control system 201 may further include a processing module 24. The processing module 24 is coupled to the remote-control device 21, the screen 22 and the marking device 23. The remote-control device 21 controls the processing module 24 to control the operation B1 of the screen 22. In the reference direction U21, the remote-control device 21 may instruct the processing module 24 to cause the cursor H21 to be located at the predetermined position P21. The processing module 24 controls the marking device 23 to display the pattern G21, and may control the pattern G21 to flicker at the specific frequency. For instance, the remote-control device 21 controls the processing module 24 to cause the marking device 23 to display the pattern G21. The processing module 24 may have a program and displays a digital content in the operation area 222 for displaying the pattern G21 by using the program. In one embodiment, the processing module 24 includes the marking device 23.

In one embodiment, a control method for calibrating a screen 22 is provided according to the illustration in FIG. 2, wherein the screen 22 has a geometric reference 221 for an operation B1. The control method includes the following steps. A pattern G21 associated with the geometric reference 221 is displayed on the screen 22. A remote-control device 21 is provided. A pattern G22 associated with the pattern G21 is generated, wherein the pattern G22 has a reference orientation NG22. The pattern G22 is transformed according to the reference orientation NG22 to obtain a geometric reference GQ2 for calibrating the geometric reference 221. Additionally, the remote-control device 21 is caused to control the operation B1 of the screen 22 based on the geometric reference GQ2.

In one embodiment, the pattern G22 has a shape center CN2 and a shape principal axis AX2. The reference orientation NG22 includes the shape center CN2 and a shape principal-axis direction FAX2, wherein the shape principal-axis direction FAX2 is a direction of the shape principal axis AX2. For instance, the remote-control device 21 may has a predetermined reference coordinate system, and the reference orientation NG22 refers to the predetermined reference coordinate system. For instance, the image-sensing area 211K of the image-sensing unit 211 has the predetermined reference coordinate system.

In one embodiment, the remote-control device 21 obtains a signal S11 from the screen 22. The signal S11 represents an image Q21 having a geometric reference Q221 and the pattern G22, wherein the geometric reference Q221 has a reference orientation NQ21. The remote-control device 21 transforms the pattern G22 into a pattern G23 according to a relationship RF1 between the reference orientation NG22 and the reference orientation NQ21, and defines the geometric reference 221 as a geometric reference GQ2 according to the pattern G23 for controlling the operation B1 of the screen 22.

For instance, the geometric reference Q211 has a shape center CN1 and a shape principal axis AX1. The reference orientation NQ21 includes the shape center CN1 and a shape principal-axis direction FAX1, wherein the shape principal-axis direction FAX1 is a direction of the shape principal axis AX1. For instance, the relationship RF1 between the reference orientation NG22 and the reference orientation NQ21 includes a position relationship between the shape center CN1 and the shape center CN2, and a direction relationship between the shape principal-axis direction FAX1 and the shape principal-axis direction FAX2. For instance, the control unit 214 of the remote-control device 21 obtains a transformation parameter PM1 according to the relationship RF1, and transforms the pattern G22 into the pattern G23 according to the transformation parameter PM1.

For instance, the transformation parameter PM1 is configured to correct a sensing error, which is derived from an alignment error between the remote-control device 21 and the screen 22. For instance, the pattern G23 has a reference orientation NG23, and the reference orientation NG23 includes the shape center CN3 and a shape principal-axis direction FAX3, wherein the shape principal-axis direction FAX3 is a direction of the shape principal axis AX3, and the shape principal-axis direction FAX3 is aligned with the shape principal-axis direction FAX1. For instance, each of the shape principal-axis directions FAX1, FAX2 and FAX3 is a respective geometric principal-axis direction.

In one embodiment, a remote-control device 21 for controlling an operation B1 of a screen 22 is provided according to the illustration in FIG. 2, wherein the screen 22 has a geometric reference 221 and a pattern G21 associated with the geometric reference 221. The remote-control device 21 includes a pattern generator 27 and a defining medium 28. The pattern generator 27 generates a pattern G22 associated with the pattern G21, wherein the pattern G22 has a reference orientation NG22. The defining medium 28 defines the geometric reference 221 according to the reference orientation NG22 for controlling the operation B1 of the screen 22. For instance, the pattern generator 27 is the image-sensing unit 211, and the defining medium 28 is the control unit 214. In one embodiment, the control unit 214 includes the pattern generator 27 and the defining medium 28, wherein the defining medium 28 is coupled to the pattern generator 27.

In one embodiment, the remote-control device 21 further includes a reference direction U21, a motion-sensing unit 212 and a communication interface unit 213. The pattern generator 27 has an image-sensing area 211K, and senses the pattern G21 to generate a signal S11 from the screen 22 through the image-sensing area 211K in the reference direction U21, wherein the signal S11 represents an image Q21 including a geometric reference Q211 and the pattern G22. The motion-sensing unit 212 generates a signal S21 in the reference direction U21. The communication interface unit 213 is coupled to the defining medium 28 for controlling the operation B1.

In one embodiment, the geometric reference 221 identifies an operation area 222 on the screen 22. The operation area 222 has a cursor H21 and a predetermined position P21. The pattern G22 and the geometric reference Q211 have a geometric relationship R11 therebetween. The defining medium 28 is coupled to the communication interface unit 213, the pattern generator 27 and the motion-sensing unit 212, receives the signal S11, arranges a geometric relationship R31 between the geometric reference Q211 and the image-sensing area 211K, obtains the geometric relationship R11 according to the signal S11, transforms the pattern G22 into a pattern G23 according to the geometric relationship R11, obtains a geometric reference GQ2 according to the pattern G23 to define the geometric reference 221, and correlates the reference direction U21 with the predetermined position P21 according to the geometric relationship R11 and the signal S21.

In one embodiment, the defining medium 28 correlates the reference direction U21 with the predetermined position P21 according to the geometric relationship R11 and the estimated direction F21. The pattern G23 and the geometric reference Q211 have a geometric relationship R12 therebetween. The defining medium 28 obtains a geometric relationship RA1 between the pattern G21 and the geometric reference 211 for obtaining the geometric reference GQ2. The defining medium 28 causes the cursor H21 to be located at the predetermined position P21 in the reference direction U21. The geometric reference Q211 has a shape center CN1 and a shape principal axis AX1, the pattern G22 has a shape center CN1 and a shape principal axis AX2, and the pattern G23 has a shape center CN3 and a shape principal axis AX3. The geometric relationship R11 includes a position relationship between the shape center CN1 and the shape center CN2 and a direction relationship between the shape principal axis AX1 and the shape principal axis AX2. The shape principal axis AX2 has a direction FAX2, and the reference orientation NG22 includes the shape center CN2 and the direction FAX2.

In one embodiment, the remote-control device 21 obtains a transformation parameter PM1 according to the geometric relationship R11, and transforms the pattern G22 into the pattern G23 according to the transformation parameter PM1, wherein the transformation parameter PM1 includes a displacement parameter associated with the position relationship and a rotation parameter associated with the direction relationship. The geometric relationship R12 includes a first relationship and a second relationship, wherein the first relationship is that the shape center CN1 coincides with the shape center CN3, and the second relationship is that the shape principal axis AX1 is aligned with the shape principal axis AX3.

In one embodiment, the operation area 222 has a first resolution, the second geometric reference Q211 defines a first area having a second resolution provided by the image Q21, and the defining medium 28 uses the first and the second resolutions to correlate the pattern G23 with the geometric reference 221. The pattern G23 and the operation area 222 have a first dimension and a second dimension corresponding to the first dimension, respectively. The defining medium 28 obtains a scale relationship between the first and the second dimensions, and transforms the operation area 222 into the geometric reference GQ2 according to the scale relationship and the pattern G23.

In one embodiment, a control method for controlling an operation B1 of a screen 22 is provided according to the illustration in FIG. 2, wherein the screen 22 has a geometric reference 221. The control method includes the following steps. A pattern G21 associated with the geometric reference 221 is displayed on the screen 22. A remote-control device 21 is provided. A pattern G22 associated with the pattern G21 is generated, wherein the pattern G22 has a reference orientation NG22. Additionally, the geometric reference 221 is calibrated in the remote-control device 21 according to the reference orientation NG22 for controlling the operation B1 of the screen 22.

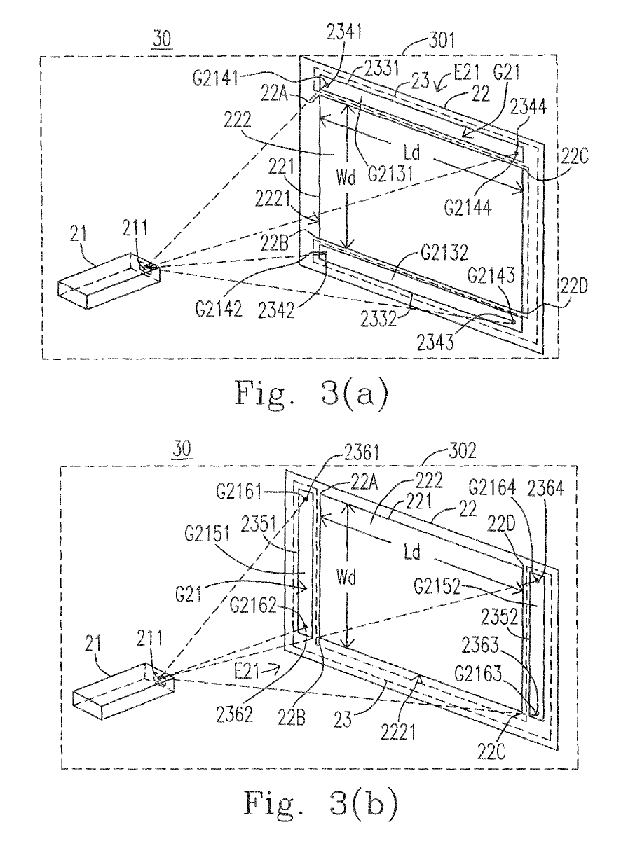

Please refer to FIG. 3(a), FIG. 3(b) and FIG. 3(c), which are schematic diagrams showing three configurations 301, 302 and 303 of a control system 30 according to the second embodiment of the present invention, respectively. As shown in FIG. 3(a), FIG. 3(b) and FIG. 3(c), each of the configurations 301, 302 and 303 includes a remote-control device 21, a screen 22 and a marking device 23. The marking device 23 displays a pattern G21 on the screen 22. The remote-control device 21 includes an image-sensing unit 211. For instance, the image-sensing unit 211 is a complementary metal-oxide semiconductor (CMOS) image sensor or a charge-coupled-device (CCD) image sensor.

The screen 22 has an operation area 222, which has a geometric reference 221; and the geometric reference 221 is configured to identify the operation area 222. The operation area 222 has a length Ld, a width Wd, and four corner points 22A, 22B, 22C and 22D. For instance, the operation area 222 is a display area, and may be located on the screen 22. The marking device 23 is coupled to the screen 22, and displays the pattern G21 associated with the corner points 22A, 22B, 22C and 22D on the screen 22.

In FIG. 3(a), the marking device 23 in the configuration 301 includes two light-bar generating units 2331 and 2332, and four light-spot generating units 2341, 2342, 2343 and 2344. The pattern G21 in the configuration 301 includes a characteristic rectangle E21, and two light bars G2131 and G2132 and four light spots G2141, G2142, G2143 and G2144 for defining the characteristic rectangle E21, wherein the two light bars G2131 and G2132 are configured to be auxiliary and horizontal. The light-bar generating units 2331 and 2332 and the light-spot generating units 2341, 2342, 2343 and 2344 generate the light bars G2131 and G2132 and the light spots G2141, G2142, G2143 and G2144, respectively. The light spots G2141 and G2144 are located in the light bar G2131, and the light spots G2142 and G2143 are located in the light bar G2132.

In FIG. 3(b), the marking device 23 in the configuration 302 includes two light-bar generating units 2351 and 2352, and four light-spot generating units 2361, 2362, 2363 and 2364. The pattern G21 in the configuration 302 includes a characteristic rectangle E21, and two light bars G2151 and G2152 and four light spots G2161, G2162, G2163 and G2164 for defining the characteristic rectangle E21, wherein the two light bars G2151 and G2152 are configured to be auxiliary and vertical. The light-bar generating units 2351 and 2352 and the light-spot generating units 2361, 2362, 2363 and 2364 generate the light bars G2151 and G2152 and the light spots G2161, G2162, G2163 and G2164, respectively. The light spots G2161 and G2162 are located in the light bar G2151, and the light spots G2163 and G2164 are located in the light bar G2152.

In FIG. 3(a) and FIG. 3(b), each of the plurality of light-bar generating units and the plurality of light-spot generating units is a respective external light-source device, and the plurality of light-bar generating units and the plurality of light-spot generating units are installed in the periphery of the operation area 222 in upper-lower symmetry or left-right symmetry about the operation area 222. The remote-control device 21 may be a motion-sensing remote controller or a 3D air mouse device. The pattern G21 is configured to indicate the perimeter 2221 and the corner points 22A, 22B, 22C and 22D of the operation area 222, and is configured to determine the absolute-coordinate position of the cursor moving in the operation area 222.

In FIG. 3(c), the marking device 23 in the configuration 303 includes a display device 237. For instance, the screen 22 is a surface portion of the display device 237. The marking device 23 plays a digital content, including the pattern G21, in the operation area 222, wherein the pattern G21 includes a characteristic rectangle E21, and four light spots G2171, G2172, G2173 and G2174 for defining the characteristic rectangle E21. For instance, the marking device 23 arranges the four light spots G2171, G2172, G2173 and G2174 to be played at the four corner points 22A, 22B, 22C and 22D, respectively. The abovementioned method includes employing the external light-source device or the digital content to play the light spots. In addition to operate the light spots with normal illumination, the light spots may be caused to flicker at a specific frequency for definitely distinguishing the light spots from the external noise or the background light (the background noise).

Additionally, the remote-control device 21 receives the light spots, processes the received light spots, obtains the geometric reference GQ2 by calculations, and utilizes the geometric reference GQ2 to define the coordinates of the four corner points 22A, 22B, 22C and 22D of the operation area 222 (or the four reference positions 221A, 221B, 221C and 221D of the geometric reference 221) for indicating the perimeter 2221 of the operation area 222 in the remote-control device 21, wherein the upper left corner point 22A, the lower left corner point 22B, the lower right corner point 22C and the upper right corner point 22D have coordinates A1(XL, YU), B1(XL, YD), C1(XR, YD) and D1(XR, YU), respectively. The four light spots in each of the configurations 301, 302 and 303 have a characteristic rectangle.

The image-sensing unit 211 of the remote-control device 21 has a pixel matrix unit (not shown), which has an image-sensing area 211K. The remote-control device 21 has a reference direction U21, and obtains the signal S11 representing the image Q21 of the screen 22 from the screen 22 through the image-sensing area 211K in the reference direction U21. The image Q21 in the pixel matrix unit has an image-sensing range Q212, a geometric reference Q211 and the pattern G22 associated with the pattern G21, wherein the image-sensing range Q212 represents the range of the image-sensing area 211K. For instance, the image-sensing area 211K may be a matrix sensing area, a pixel matrix sensing area or an image-sensor sensing area. The image-sensing unit 211 generates the signal S11 having the image Q21. The control unit 214 of the remote-control device 21 receives the signal S11, and processing the image Q21 according to the signal S11.

In one embodiment, the control unit 214 arranges a geometric relationship R41 between the geometric reference Q211 and the image-sensing range Q212. For instance, the geometric reference Q211 is configured to define the image-sensing range Q212. For instance, the geometric reference Q211 is configured to define a specific range Q2121 in the image-sensing range Q212. The specific range Q2121 and the image-sensing range Q212 have a specific geometric relationship therebetween, and the specific geometric relationship may include at least one selected from a group consisting of the same shape, the same shape center and the same shape principal-axis direction.

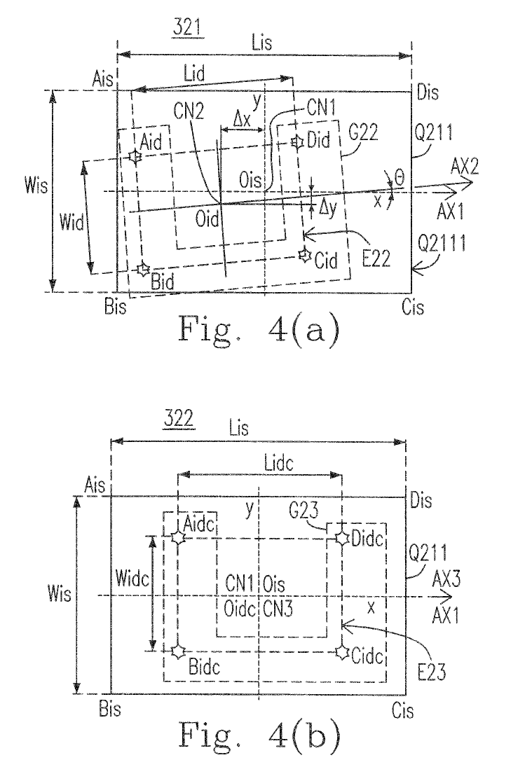

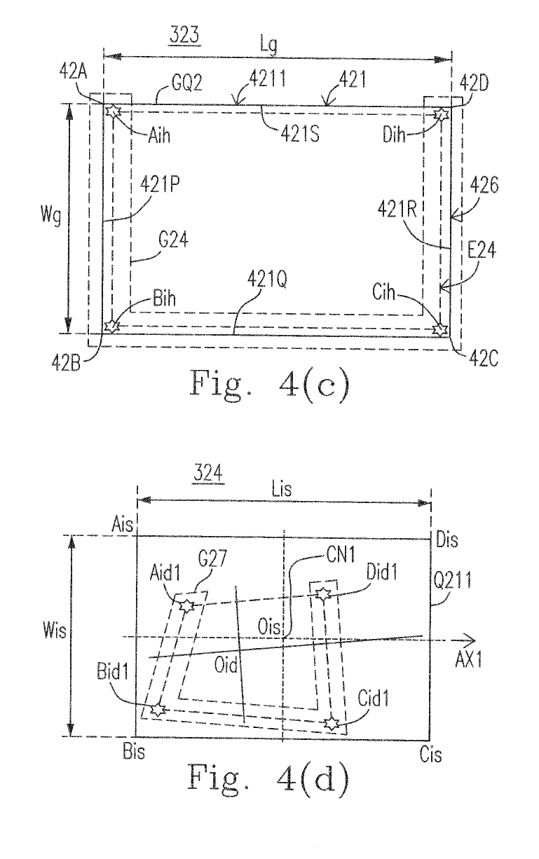

Please refer to FIG. 4(a), FIG. 4(b) and FIG. 4(c), which are schematic diagrams showing three pattern models 321, 322 and 323 of the control system 30 according to the second embodiment of the present invention, respectively. The control unit 214 of the control system 30 may obtain the pattern models 321, 322 and 323 according to the image Q21. As shown in FIG. 4(a), the pattern model 321 includes the geometric reference Q211 and the pattern G22 associated with the pattern G21. For instance, the geometric reference Q211 is configured to define the image-sensing range Q212. The geometric reference Q211 has a reference rectangle Q2111, which has an image-sensing length Lis, an image-sensing width Wis, an image-sensing area center point Ois (or the shape center CN1), a shape principal axis AX1 and four corner points Ais, Bis, Cis and Dis. For instance, the shape principal axis AX1 is aligned with the abscissa axis x. The pattern G22 has a characteristic rectangle E22, which has a characteristic rectangular area, wherein the characteristic rectangular area may be a pattern pick-up area or a pattern image pick-up display area.

The characteristic rectangle E22 has a pattern area length Lid, a pattern area width Wid, a pattern area center point Oid (or the shape center CN2), a shape principal axis AX2 and four corner points Aid, Bid, Cid and Did. The displacement from the image-sensing area center point Ois to the pattern area center point Oid has a component in a direction of the abscissa axis x, which is expressed as Δx. The displacement from the image-sensing area center point Ois to the pattern area center point Oid has a component in a direction of the ordinate axis y, which is expressed as Δy. The space from the abscissa (ordinate) axis (or the orientation or the shape principal axis AX1) of the geometric reference Q211 to the abscissa (or ordinate) axis (or the orientation or the shape principal axis AX2) of the pattern G22 has an angle θ. The control unit 214 obtains the geometric relationship R11 between the pattern G22 and the geometric reference Q211 by using the abovementioned analysis. The pattern G22 defines a first pattern area, and the geometric reference Q211 defines a second pattern area.

For instance, the remote-control device 21 employs a coordinate transformation to transform the pattern G22 into the pattern G23 for calibrating the screen 22. In FIG. 4(a), the image-sensing area center point Ois is the center point of the corner points Ais, Bis, Cis and Dis; and the pattern area center point Oid is the center point of the corner points Aid, Bid, Cid and Did. The control unit 214 of the remote-control device 21 causes the pattern area center point Oid to coincide with the image-sensing area center point Ois. In the state that the pattern area center point Oid has coincided with the image-sensing area center point Ois, the pattern G22 has a new center point Oidc.

Afterward, the new center point Oidc serves as a rotation center point, and the pattern G22 is rotated by an angle (−θ) of the angle θ around the new center point Oidc in the plane based on the abscissa and the ordinate axes of the geometric reference Q211. Therefore, the angle θ between the pattern G22 and the geometric reference Q211 will disappear due to the rotation, wherein the abscissa (or ordinate) axis or the orientation of the pattern G22 will coincide with that of the geometric reference Q211, or the abscissa (or ordinate) axis or the orientation of the first pattern area will coincide with that of the second pattern area. As shown in FIG. 4(b), the pattern model includes the geometric reference Q211 and the pattern G23.

The control unit 214 obtains a transformation parameter PM1 according to the geometric relationship R11, and transforms the pattern G22 into the pattern G23 according to the transformation parameter PM1, wherein the transformation parameter PM1 includes a displacement parameter and a rotation parameter. For instance, the displacement parameter includes the displacement Δx and the displacement Δy, and the rotation parameter includes the angle (−θ). For instance, the pattern G23 has a characteristic rectangle E23, which has a characteristic rectangular area. The characteristic rectangle E23 has a pattern area length Lidc, a pattern area width Widc, a pattern area center point Oidc (or the shape center CN3), a shape principal axis AX3 and four corner points Aidc, Bidc, Cidc and Didc, wherein there are the relationships of Lidc=Lid and Widc=Wid. In the pattern model 322, the pattern G23 and the geometric reference Q211 have a geometric relationship R12 therebetween.

The pattern G22 and the pattern G23 have the following relationships therebetween. The corner point Aid and the corner point Cid defines a straight line Aid_Cid, the corner point Bid and the corner point Did defines a straight line Bid_Did, and the straight line Aid_Cid crosses the straight line Bid_Did at an intersection point. The pattern area center point Oid may be obtained from the intersection point by solving the simultaneous equations of the straight line Aid_Cid and the straight line Bid_Did. The angle θ may be obtained from the formula

$$θ = {tan}^{- 1} \frac{V}{H} ,$$

wherein there are the relationships of V=y_Did−y_Aid and H=x_Did−x_Aid, y_Did represents the ordinate coordinate of the corner point Did, and x_Aid represents the abscissa coordinate of the corner point Aid. As shown in FIG. 4(a) and FIG. 4(b), the regular pattern G23 is completely located in the geometric reference Q211. The pattern G23 has the four corner points Aidc, Bidc, Cidc and Didc. A calculation formula is employed to translate the pattern G22 by the displacement Δx in the horizontal direction, translate the pattern G22 by the displacement Δy in the vertical direction, and rotate the pattern G22 by the angle θ for forming the pattern G23. The calculation formula has the form

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} ) + ( \begin{matrix}Δ x \\ Δ y\end{matrix} ) ,$$

wherein x′: x_Aidc, x_Bidc, x_Cidc, x_Didc; y′: y_Aidc, y_Bidc, y_XCidc, y_Didc; x: x_Aid, x_Bid, x_Cid, x_Did; y′: y_Aid, y_Bid, y_XCid, y_Did; (x, y) represents the coordinate of any one selected from a group consisting of the corner points Aid, Bid, Cid and Did; and (x′, y′) represents the coordinate of any one selected from a group consisting of the corner points Aidc, Bidc, Cidc and Didc.

The pattern area length Lidc and the pattern area width Widc of the pattern G23 are equal to the pattern area length Lid and the pattern area width Wid of the pattern G22, respectively. The control unit 214 may utilize a length-scaling factor SL and a width-scaling factor SW to convert the pattern area length Lidc and the pattern area width Widc into an adjusted pattern area length and an adjusted pattern area width, respectively, so that the adjusted pattern area length and the adjusted pattern area width are consistent with the length Ld and the width Wd of the operation area 222, respectively. The length-scaling factor SL may has a relationship of SL=Ld/Lidc, and the width-scaling factor SW may has a relationship of SW=Wd/Widc; that is to say, Ld=Lidc×SL, and Wd=Widc×SW.

In the practical application, the control unit 214 may use the resolution of the operation area 222 and the resolution of the geometric reference Q211 to obtain the length-scaling factor SL and the width-scaling factor SW. The resolutions of the common image sensor may have the following types: the CIF type has the resolution of 352×288 pixels being about 100,000 pixels; the VGA type has the resolution of 640×480 pixels being about 300,000 pixels; the SVGA type has the resolution of 800×600 pixels being about 480,000 pixels; the XGA type has the resolution of 1024×768 pixels being about 790,000 pixels; and the HD type has the resolution of 1280×960 pixels being about 1.2M pixels. The resolutions of the common display device for the personal computer may have the following types: 800×600 pixels, 1024×600 pixels, 1024×768 pixels, 1280×768 pixels and 1280×800 pixels.

As shown in FIG. 4(c), the pattern model 323 includes a pattern G24 and the geometric reference GQ2, wherein the geometric reference GQ2 has a reference rectangle 426, and the reference rectangle 426 has four corner points 42A, 42B, 42C and 42D, which are configured to define the geometric reference 221 and the operation area 222. The control unit 214 converts the pattern G23 according to the length-scaling factor SL and the width-scaling factor SW to obtain the corner points 42A, 42B, 42C and 42D, wherein the corner points Aidc, Bidc, Cidc and Didc of the pattern G23 are converted into the corner points 42A, 42B, 42C and 42D, respectively, which are configured to define the four corner points 22A, 22B, 22C and 22D of the operation area 222, respectively. In one embodiment, the pattern G21 is converted into the pattern G22, and the pattern G22 is transformed into the corner points 42A, 42B, 42C and 42D by employing the image processing, the coordinate transformation and the scale transformation. The corner points 42A, 42B, 42C and 42D define a pattern area 421, which has a length Lg and a width Wg.

The control unit 214 stores the coordinates of the corner points 42A, 42B, 42C and 42D, and defines the pattern area 421 and a perimeter 4211 of the pattern area 421 according to the coordinates of the corner points 42A, 42B, 42C and 42D, wherein the perimeter 4211 includes four boundaries 421P, 421Q, 421R and 421S, and the length Lg and the width Wg of the pattern area 421 are equal to the length Ld and the width Wd of the operation area 222, respectively. In this way, the perimeter 4211 of the pattern area 421 and the perimeter 2221 of the operation area 222 may have a direct correspondence relationship of the same dimensions and the same orientations. The remote-control device 21 regards the coordinates of the corner points 42A, 42B, 42C and 42D as reference coordinates to start a cursor to move with a motion of the remote-control device 21.

In one embodiment, the pattern G21 and the corner points 22A, 22B, 22C and 22D of the operation area 222 have a first relationship thereamong, wherein the corner points 22A, 22B, 22C and 22D have the coordinates A1(XL, YU), B1(XL, YD), C1(XR, YD) and D1(XR, YU), respectively. For instance, the light spots G2171, G2172, G2173 and G2174 of the pattern G21 and the coordinates A1(XL, YU), B1(XL, YD), C1(XR, YD) and D1(XR, YU), respectively corresponding to the light spots G2171, G2172, G2173 and G2174, have a position relationship thereamong. The remote-control device 21 may obtain the position relationship and dimensions of the operation area 222 beforehand. According to the pattern model 322, the position relationship and the dimensions of the operation area 222, the remote-control device 21 may obtain a second relationship between the pattern G23 and the operation area 222, and transform the pattern G23 into the pattern G24. The pattern G24 has a characteristic rectangle E24, which has four corner points Aih, Bih, Cih and Dih. The remote-control device 21 obtains coordinates of the corner points Aih, Bih, Cih and Dih to define the corner points 42A, 42B, 42C and 42D of the geometric reference GQ2, respectively, and uses the corner points 42A, 42B, 42C and 42D to define the perimeter 2221 of the operation area 222 and respectively define the corner points 22A, 22B, 22C and 22D of the operation area 222. For instance, the geometric center of the characteristic rectangle E24 may be located at the image-sensing area center point Ois (or the shape center CN1).

However, in the condition of one practical hand-held operation, the light-sensing surface of the image-sensing unit 211 is located in the surface portion of the remote-control device 21, and it is hardly possible that the light-sensing surface is parallel with the screen 22. Therefore, the practical sensed pattern on the light-sensing surface of the image-sensing unit 211 for the four positioning light spots will be similar to that shown in FIG. 4(d). FIG. 4(d) is a schematic diagram showing a pattern model 324 of the control system 30 according to the second embodiment of the present invention. In FIG. 4(d), the pattern model 324 includes the geometric reference Q211 and a pattern G27 associated with the pattern G21. For instance, the geometric reference Q211 is configured to define a reference area of the image Q21. The pattern G27 has four endpoints Aid1, Bid1, Cid1 and Did1. As shown in FIG. 4(d), the pattern G27 is a quadrilateral, and it is difficult for the pattern G27 to be a rectangle, where any two neighboring sides are perpendicular to each other. It is less suitable to apply such quadrilateral to the calculation methods for the pattern models 321, 322 and 323.

In order to solve this problem, the control unit 214 is configured to have an image pick-up calculation program. The image-sensing unit 211 senses the pattern G21 to generate the signal S11 in an orientation (or a posture) of the remote-control device 21, wherein the signal S11 represents the image Q21 and is provided to the control unit 214. When the control unit 214 uses the image pick-up calculation program to process the image Q21 (or the signal S11) and finds a first condition is satisfied, the control unit 214 sends out a specific signal to prompt a second condition to the user and makes calculations as the calculation method provided for the pattern models 321, 322 and 323. For instance, the first condition is that a pattern derived from the pattern G27 in the image Q21 has been similar to the characteristic rectangle E22 in FIG. 4(a) in a predetermined error. The second condition is that a quadrilateral formed by sensing the four light spots in the current orientation of the hand-held remote-control device 21 can be transformed into a characteristic rectangle. For instance, the control unit 214 causes the derived pattern to be the pattern G22, wherein the pattern G22 has a characteristic rectangle E22. For instance, the control unit 214 uses the image pick-up calculation program to transform the endpoints Aid1, Bid1, Cid1 and Did1 of the pattern G27 into the endpoints Aid, Bid, Cid and Did of the pattern G22 in FIG. 4(a), respectively.

Additionally, the motion-sensing unit 212 of the remote-control device 21 includes the gyroscope 2121, the accelerometer 2122 and the electronic compass 2123. In one embodiment, when the control unit 214 finds that the derived pattern has been similar to a rectangle in a predertemined error, the control unit 214 of the remote-control device 21 stores the read values of the gyroscope 2121, the accelerometer 2122 and the electronic compass 2123 to serve as the reference values of the subsequent operation, wherein the subsequent operation estimates the orientation or the motion of the remote-control device 21.

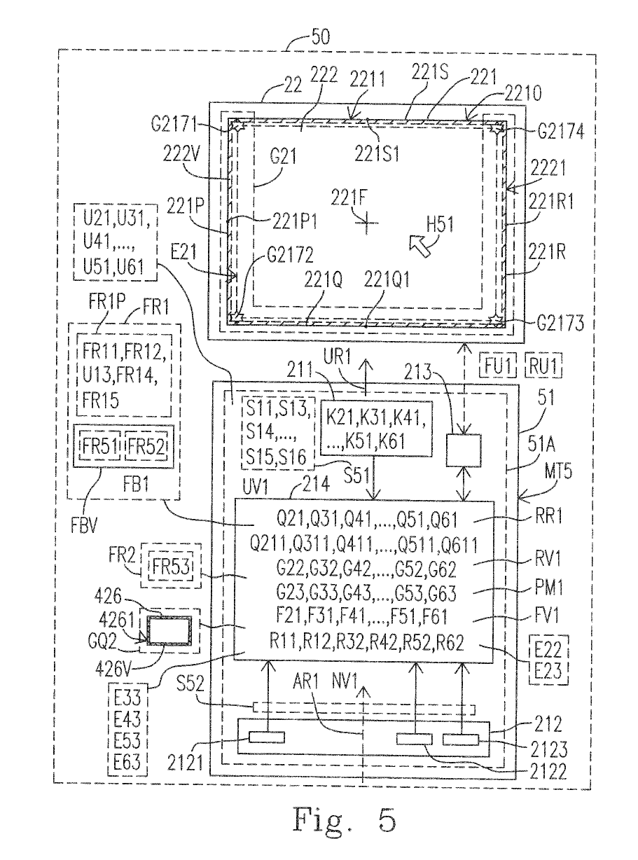

Please refer to FIG. 5, which is a schematic diagram showing a control system 50 according to the third embodiment of the present invention. As shown, the control system 50 includes a screen 22 and a control device 51 for controlling the screen 22. The screen 22 has a geometric reference 221 for an operation B5 and a pattern G21 associated with the geometric reference 221. The control device 51 is configured to sequentially have a plurality of reference directions U21, U31, U41, . . . , U51 and U61. For instance, the control device 51 is a remote-control device 21 as shown in FIG. 2. The plurality of reference directions U21, U31, U41, . . . , U51 and U61 defines a reference direction range FU1 corresponding to the geometric reference 221.

In FIG. 5, the pattern G21 has light spots G2171, G2172, G2173 and G2174. For instance, the control device 51 has an orientation NV and a reference axis AR1, wherein the reference axis AR1 has a reference direction UR1. For instance, the orientation NV1 has the reference axis AR1. When the control device 51 has a motion to cause the orientation NV1 change, the reference direction UR1 changes with the change of the orientation NV1 to cause the plurality of reference directions U21, U31, U41, . . . , U51 and U61 to represent the reference direction UR1 at respective corresponding different times, and cause the control device 51 to sequentially have the plurality of reference directions U21, U31, U41, . . . , U51 and U61, wherein the plurality of reference directions U21, U31, U41, . . . , U51 and U61 may be arranged in any order.

In one embodiment, the control device 51 includes a processing unit 51A. The processing unit 51A generates a plurality of patterns G22, G32, G42, . . . , G52 and G62 associated with the pattern G21 in the plurality of reference directions U21, U31, U41, . . . , U51 and U61, respectively, estimates the reference direction range FU1 according to the plurality of reference directions U21, U31, U41, . . . , U51 and U61 and the plurality of patterns G22, G32, G42, . . . , G52 and G62 for controlling the operation B5 of the screen 22.

In one embodiment, the control device 51 is configured to sequentially have a plurality of reference directions U21, U31, U41, . . . , U51 and U61 and an operating direction UV1. The plurality of reference directions U21, U31, U41, . . . , U51 and U61 defines a reference direction range FU1 corresponding to the geometric reference 221; and the operating direction UV1 and the reference direction range FU1 have a relationship RU1 therebetween. The processing unit 51A generates a plurality of patterns G22, G32, G42, . . . , G52 and G62 associated with the pattern G21 in the plurality of reference directions U21, U31, U41, . . . , U51 and U61, respectively, estimates the reference direction range FU1 according to the plurality of reference directions U21, U31, U41, . . . , U51 and U61 and the plurality of patterns G22, G32, G42, . . . , G52 and G62, and controls the operation B5 of the screen 22 by estimating the relationship RU1.

For instance, the processing unit 51A senses the plurality of reference directions U21, U31, U41, . . . , U51 and U61 to generate a plurality of estimated directions F21, F31, F41, . . . , F51 and F61 in the plurality of reference directions U21, U31, U41, . . . , U51 and U61, respectively, obtains an estimated direction range FR1 for estimating the reference direction range FU1 according to the plurality of estimated directions F21, F31, F41, . . . , F51 and F61 and the plurality of patterns G22, G32, G42, . . . , G52 and G62, generates an estimated direction FV1 by sensing the operating direction UV1, obtains a relationship RV1 between the estimated direction FV1 and the estimated direction range FR1 for estimating the relationship RU1, and controls the operation B5 of the screen 22 according to the relationship RV1.

For instance, the processing unit 51A, according to the plurality of estimated directions F21, F31, F41, . . . , F51 and F61 and the plurality of patterns G22, G32, G42, . . . G52 and G62, obtains a geometric reference GQ2 for defining the geometric reference 221, and a correspondence relationship RR1 between the geometric reference GQ2 and the estimated direction range FR1 for controlling the operation B5 of the screen 22. The screen 22 has an operation area 222, and the geometric reference 221 defines the operation area 222. For instance, the operation area 222 is a display area and has a perimeter area 222V which has the perimeter 2221; and a cursor H51 displayed on the operation area 222. For instance, the operation B5 is an operation associated with the screen 22 or an action of the cursor H51. For instance, the operation B5 of the screen 22 is an operation of determining a specific position on the screen 22.

For instance, the geometric reference 221 has a reference area 2210 corresponding to the estimated direction range FR1 for defining the operation area 222. For instance, the geometric reference 221 has a reference rectangle 2211, which has a centroid 221F, an upper boundary 221S, a lower boundary 221Q, a left boundary 221P and a right boundary 221R; and the upper boundary 221S, the lower boundary 221Q, the left boundary 221P and the right boundary 221R have four specific positions 221S1, 221Q1, 221P1 and 221R1, respectively. For instance, the specific positions 221S1, 221Q1, 221P1 and 221R1 are the center points of the upper boundary 221S, the lower boundary 221Q, the left boundary 221P and the right boundary 221R, respectively.

For instance, the operating direction UV1 is a variable reference direction, and the estimated direction FV1 is a variable estimated direction. The processing unit 51A causes the cursor H51 to stay on the perimeter area 222V of the operation area 222 when the estimated direction FV1 varies outside the estimated direction range FR1. The processing unit 51A causes the cursor H51 to move into the operation area 222 according to the relationship RV1 and the correspondence relationship RR1 when the estimated direction FV1 enters the estimated direction range FR1 from an outside of the estimated direction range FR1.

The plurality of reference directions U21, U31, U41, . . . , U51 and U61 includes the reference directions U21, U31, U41, U51 and U61 respectively corresponding to the centroid 221F, and the specific position 221S1, the specific position 221Q1, the specific position 221P1 and the specific position 221R1. The plurality of patterns G22, G32, G42, . . . , G52 and G62 includes the patterns G22, G32, G42, G52 and G62 respectively corresponding to the reference directions U21, U31, U41, U51 and U61. The plurality of estimated directions F21, F31, F41, . . . , F51 and F61 includes the estimated directions F21, F31, F41, . . . , F51 and F61 respectively corresponding to the reference directions U21, U31, U41, U51 and U61.

The processing unit 51A generates a plurality of signals S11, S13, . . . , S14, S15 and S16 in the plurality of reference directions U21, U31, U41, . . . , U51 and U61, respectively, wherein the plurality of signals S11, S13, . . . , S14, S15 and S16 represent a plurality of images Q21, Q31, . . . , Q41, Q51 and Q61, respectively, and the plurality of images Q21, Q31, . . . , Q41, Q51 and Q61 includes the plurality of patterns G22, G32, G42, . . . , G52 and G62, respectively, and further includes a plurality of geometric references Q211, Q311, Q411, . . . , Q511 and Q611, respectively. The plurality of geometric references Q211, Q311, Q411, . . . , Q511 and Q611 includes the geometric references Q211, Q311, Q411, Q511 and Q611 respectively corresponding to the patterns G22, G32, G42, G52 and G62. For instance, the geometric references Q211, Q311, Q411, Q511 and Q611 are fixed, and define reference areas of the Q21, Q31, Q41, Q51 and Q61, respectively.

The processing unit 51A obtains a geometric relationship R11 between the pattern G22 and the geometric reference Q211, generates a transformation parameter PM1 according to the geometric relationship R11, transforms the pattern G22 into a pattern G23 according to the transformation parameter PM1, and obtains the geometric reference GQ2 according to the pattern G23, wherein the pattern G23 and the geometric reference Q211 have a geometric relationship R12 therebetween. The processing unit 51A transforms the patterns G32, G42, G52 and G62 into patterns G33, G43, G53 and G63 respectively according to the transformation parameter PM1 and the geometric references Q311, Q411, Q511 and Q611, wherein the pattern G33 and the geometric reference Q311 have a geometric relationship R32 therebetween, the pattern G43 and the geometric reference Q411 have a geometric relationship R42 therebetween, the pattern G53 and the geometric reference Q511 have a geometric relationship R52 therebetween, and the pattern G63 and the geometric reference Q611 have a geometric relationship R62 therebetween.

For instance, the pattern G21 has a characteristic rectangle E21, which has an upper boundary, a lower boundary, a left boundary and a right boundary. The plurality of patterns G33, G43, G53 and G63 has a plurality of line segments E33, E43, E53 and E63, respectively. The plurality of line segments E33, E43, E53 and E63 correspond to the upper boundary, the lower boundary, the left boundary and the right boundary, respectively. For instance, the geometric relationship R32 includes that the line segment E33 of the pattern G33 corresponds to the lower boundary of the geometric reference Q311; the geometric relationship R42 includes that the line segment E43 of the pattern G43 corresponds to the upper boundary of the geometric reference Q411; the geometric relationship R52 includes that the line segment E53 of the pattern G53 corresponds to the right boundary of the geometric reference Q511; the geometric relationship R62 includes that the line segment E63 of the pattern G63 corresponds to the left boundary of the geometric reference Q611.

For instance, the control device 51 has a reference direction range, which corresponds to an area (such as the operation area 222) defined by the geometric reference 221. For instance, the plurality of reference directions U21, U31, U41, . . . , U51 and U61 define the reference direction range. For instance, the processing unit 51A obtains the estimated direction range FR1 according to the pattern G21 and the plurality of reference directions U21, U31, U41, . . . , U51 and U61, wherein the estimated direction range FR1 defines the reference direction range.

The processing unit 51A obtains the estimated direction range FR1 and the correspondence relationship RR1 according to the geometric reference GQ2, the estimated directions F21, F31, F41, F51 and F61, and the geometric relationships R12, R32, R42, R52 and R62 to cause the estimated direction range FR1 to correspond to the operation area 222. The estimated direction range FR1 has a direction range parameter FR1P for defining the estimated direction range FR1. The direction range parameter FR1P includes a middle-reference estimated direction FR11, an upward-limit estimated direction FR12, a downward-limit estimated direction FR13, a leftward-limit estimated direction FR14 and a rightward-limit estimated direction FR15. The estimated directions F21, F31, F41, F51 and F61 define the middle-reference direction FR11, the upward-limit direction FR12, the downward-limit direction FR13, the leftward-limit direction FR14 and the rightward-limit estimated direction FR15, respectively.

In one embodiment, the control device 51 has a motion MT5 to cause the control device 51 to sequentially point to the plurality of reference directions U21, U31, U41, . . . , U51 and U61 and the operating direction UV1. The processing unit 51A includes an image-sensing unit 211, a motion-sensing unit 212, a communication interface unit 213 and a control unit 214. The image-sensing unit 211 sequentially senses the pattern G21 in the plurality of respective reference directions U21, U31, U41, . . . , U51 and U61 to generate a signal S51, which includes the plurality of signals S11, S13, . . . , S14, S15 and S16, wherein the plurality of signals S11, S13, . . . , S14, S15 and S16 further represent a plurality of images K21, K31, K41, . . . , K51 and K61, respectively. The motion-sensing unit 212 converts the motion MT5 into a signal S52, wherein signal S52 may include the signal S21.

The control unit 214 is coupled to the image-sensing unit 211, the motion-sensing unit 212 and the communication interface unit 213, obtains the plurality of images Q21, Q31, Q41, . . . , Q51 and Q61, the transformation parameter PM1, the geometric reference GQ2, the plurality of estimated directions F21, F31, F41, . . . , F51 and F61, the geometric relationships R11, R12, R32, R42, R52 and R62, the estimated direction range FR1, the estimated direction FV1, the relationship RV1 and the correspondence relationship RR1 according to the signals S51 and S52, and controls the operation B5 of the screen 22 according to the relationship RV1 and the correspondence relationship RR1.

For instance, the motion-sensing unit 212 includes a gyroscope 2121, an accelerometer 2122 and an electronic compass 2123; and the control unit 214 is a microcontroller. The control unit 214 receives the signal S52 transmitted from the gyroscope 2121, the accelerometer 2122 and the electronic compass 2123. Under the condition that the variable orientation NV1 of the control device 51 is changed, the reference axis AR1 of the control device 51 has the plurality of reference directions U21, U31, U41, . . . , U51 and U61 and the operating direction UV1 at respective different times.

The control unit 214 may use a software program to make an operation to the signal S52 through calculations for determining the plurality of estimated directions F21, F31, F41, . . . , F51 and F61 and FV1 respectively corresponding to the plurality of reference directions U21, U31, U41, . . . , U51 and U61 and the operating direction UV1. The control unit 214 controls the operation B5 of the screen 22 through the communication interface unit 213. For instance, the communication interface unit 213 includes a radio frequency (RF)/universal serial bus (USB) transmission module, and use the RF/USB transmission module to make an output, or to receive an external signal for providing the external signal to the control unit 214.

In one embodiment, the control unit 214 has an image pick-up calculation program, obtains the image K21 in the reference direction U21, uses the image pick-up calculation program to process the image K21 for transforming the image K21 into the image Q21, and obtains the characteristic rectangle E22 of the pattern G22. For instance, the control unit 214 obtains the images K31, K41, K51 and K61 in the respective reference directions U31, U41, U52 and U61, uses the image pick-up calculation program to transform the images K31, K41, K51 and K61 respectively into the images Q31, Q41, Q51 and Q61 for standardizing the patterns G32, G42, G52 and G62, wherein the patterns G32, G42, G52 and G62 have a plurality characteristic line segments, respectively.

For instance, the control unit 214 causes the cursor H51 to move in the operation area 222 when the operating direction UV1 varies to cause the estimated direction FV1 to vary in the estimated direction range FR1. For instance, the control unit 214 causes the cursor H51 to move with a variation in an absolute coordinate of the cursor H51 according to the estimated direction FV1 and the relationship RV1. For instance, the control unit 214 causes the cursor H51 to stay on the perimeter area 222V of the operation area 222 when the operating direction UV1 varies to cause the estimated direction FV1 to vary outside the estimated direction range FR1.

For instance, the geometric reference GQ2 has a reference rectangle 426, which has a perimeter 4261 and a perimeter area 426V, wherein the perimeter area 426V has the perimeter 4261. The control unit 214 uses the geometric reference GQ2 to define the geometric reference 221 and the operation area 222. The control unit 214 obtains a direction range FR2, which is a direction range outside the estimated direction range FR1. The estimated direction range FR1 has a direction perimeter range FBV adjacent to the direction range FR2, wherein the direction perimeter range FBV and the direction range FR2 has a direction range perimeter FB1 therebetween. For instance, the direction perimeter range FBV corresponds to each of the perimeter areas 426V and 222V. The direction perimeter range FBV includes an estimated direction FR51 and an estimated direction FR52 different from the estimated direction FR51. The direction range FR2 includes an estimated direction FR53 adjacent to the direction perimeter range FBV.

For instance, the control unit 214 starts a function of a cursor-synchronization motion when the operating direction UV1 varies to cause the estimated direction FV1 to vary from the estimated direction FR53 to cross over the direction range perimeter FB1. For instance, the control unit 214 performs a coordinate compensation process when the operating direction UV1 varies to cause the estimated direction FV1 to enter the direction range FR2 from the estimated direction FR51 and then cause the estimated direction FV1 to reach the estimated direction FR52 from the direction range FR2. For instance, the control unit 214 causes the cursor H51 to stay on a specific position in the perimeter area 222V of the operation area 222 when the operating direction UV1 varies to cause the estimated direction FV1 to enter the direction range FR2 from the estimated direction FR51, wherein the specific position corresponds to the estimated direction FR51.

In one embodiment, a method for controlling a screen 22 is provided according to the illustration in FIG. 5, wherein the screen 22 has a geometric reference 221 for an operation B5. The method includes the following steps. A pattern G21 associated with the geometric reference 221 is displayed on the screen 22. A plurality of reference directions U21, U31, U41, . . . , U51 and U61 is provided, wherein the plurality of reference directions U21, U31, U41, . . . , U51 and U61 define a reference direction range FU1 corresponding to the geometric reference 221. A plurality of patterns G22, G32, G42, . . . , G52 and G62 associated with the pattern G21 is generated in the plurality of reference directions U21, U31, U41, . . . , U51 and U61, respectively. The reference direction range FU1 is estimated according to the plurality of reference directions U21, U31, U41, . . . , U51 and U61 and the plurality of patterns G22, G32, G42, . . . , G52 and G62 for controlling the operation B5 of the screen 22.

For instance, the method further includes the following steps. A control device 51 is provided, wherein the control device 51 is configured to sequentially have the plurality of reference directions U21, U31, U41, . . . , U51 and U61. The plurality of reference directions U21, U31, U41, . . . , U51 and U61 is sensed to generate a plurality of estimated directions F21, F31, F41, . . . , F51 and F61 in the plurality of reference directions U21, U31, U41, . . . , U51 and U61, respectively. An estimated direction range FR1 for estimating the reference direction range FU1, a geometric reference GQ2 for defining the geometric reference 221, and a correspondence relationship RR1 between the geometric reference GQ2 and the estimated direction range FR1 are obtained according to the plurality of estimated directions F21, F31, F41, . . . , F51 and F61 and the plurality of patterns G22, G32, G42, . . . , G52 and G62. The control device 51 is caused to have an operating direction UV1, wherein the operating direction UV1 and the reference direction range FV1 have a relationship RU1 therebetween. An estimated direction FV1 is generated by sensing the operating direction UV1, wherein the estimated direction FV1 and the estimated direction range FR1 have a relationship RV1 therebetween for estimating the relationship RU1. The relationship RV1 is obtained. Additionally, the operation B5 is controlled according to the relationship RV1.

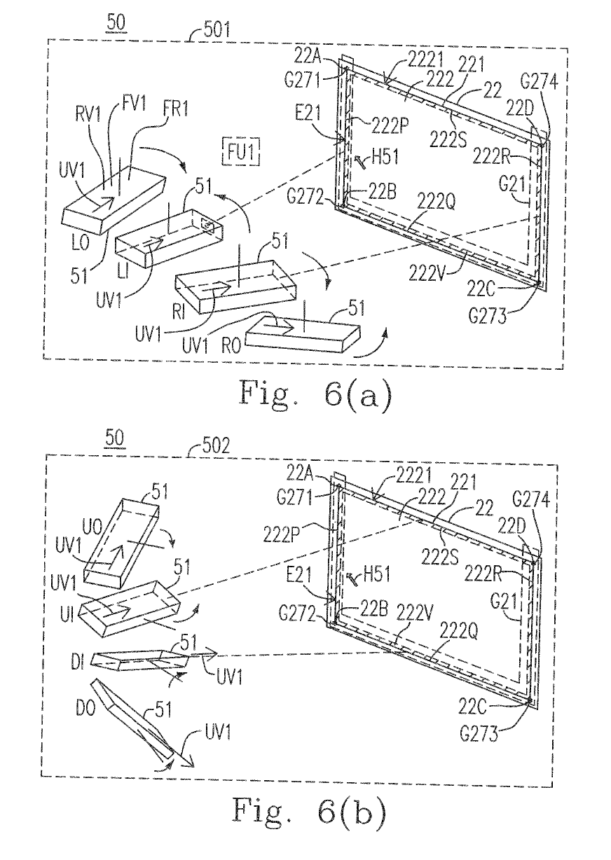

Please refer to FIG. 6(a) and FIG. 6(b), which are schematic diagrams showing a first configuration 501 and a second configuration 502 of the control system 50 according to the third embodiment of the present invention, respectively. As shown in FIG. 6(a) and FIG. 6(b), each of the first configuration 501 and the second configuration 502 includes the control device 51 and the screen 22. The control device 51 controls the screen 22. For instance, the control device 51 is a remote controller or an air mouse device. The screen 22 has the geometric reference 221 for the operation B5, the operation area 222 and the pattern G21 associated with the geometric reference 221, wherein the geometric reference 221 defines the operation area 222. As described above, the control device 51 has a plurality of reference directions. The control device 51 uses the plurality of reference directions and the pattern G21 to estimate a reference direction range FU1 corresponding to the geometric reference 221 for obtaining an estimated direction range FR1, and controls the operation B5 of the screen 22 according to the estimated direction range FR1.

In FIG. 6(a), the perimeter 2221 of the operation area 222 includes a left boundary 222P, a lower boundary 222Q, a right boundary 222R and an upper boundary 222S. The control device 51 defines the left boundary 222P, the lower boundary 222Q, the right boundary 222R, the upper boundary 222S and the correspondence relationship RR1 according to the geometric reference 221. The control device 51 has the operating direction UV1 being variable, and generates the estimated direction FV1 in the operating direction UV1, wherein the estimated direction FV1 and the estimated direction range FR1 have a relationship RV1 therebetween. The control device 51 makes a yaw motion for forming four states LO, LI, RI and RO in respective different time periods according to the relationship RV1. In FIG. 6(b), the control device 51 makes a pitch motion for forming four states UO, UI, DI and DO in respective different time periods according to the relationship RV1. In the states LI, RI, UI and DI, the estimated direction FV1 varies in the estimated direction range FR1; and in the states LO, RO, UO and DO, the estimated direction FV1 varies outside the estimated direction range FR1. For instance, in FIG. 6(a) and FIG. 6(b), in each of the states LI, RI, UI and DI, the estimated direction FV1 is configured to be expressing a respective estimated direction in the direction range perimeter FB1.

For instance, the operation area 222 has the endpoints 22A, 22B, 22C and 22D; and the pattern G21 associated with the endpoints 22A, 22B, 22C and 22D has the light spots G2171, G2172, G2173 and G2174. The image-sensing unit 211 of the control device 51 senses the pattern G21 to form the image K21. The control device 51 processes the image K21 to obtain the image Q21 and estimated coordinates respectively corresponding to the endpoints 22A, 22B, 22C and 22D, and uses the estimated coordinates to form the geometric reference GQ2. The control device 51 further uses the geometric reference GQ2 to define the geometric reference 221 or the operation area 222. For instance, the control device 51 uses a position coordinate program in the control device 51 to process estimated coordinates respectively corresponding to the endpoints 22A, 22B, 22C and 22D according to the geometric reference GQ2 so as to define a cursor motion start position and a cursor motion boundary in the states LI, RI, UI and DI.

In FIG. 6(a) and FIG. 6(b), the control device 51 includes the processing unit 51A (shown in FIG. 5) which includes the image-sensing unit 211 and a motion-sensing unit 212. The motion-sensing unit 212 includes the gyroscope 2121, the accelerometer 2122 and the electronic compass 2123. The control device 51 may use the gyroscope 2121 and the accelerometer 2122 to detect the operating direction UV1 for generating the estimated direction FV1 of the control device 51. For instance, each of the plurality of reference directions U21, U31, U41, . . . , U51 and U61 and the operating direction UV1 has a respective coordinate space; the image-sensing unit 211 has a first coordinate space; and the control device 51 uses a motion orientation-to-coordinate transformation program in the control unit 214 to transform the respective coordinate space into that consistent with the first coordinate space.

As shown in FIG. 6(a) and FIG. 6(b), the control device 51 may define the left boundary 222P, the lower boundary 222Q, the right boundary 222R and the upper boundary 222S of the operation area 222 beforehand. When the control device 51 makes a yaw motion control the cursor H51 in a horizontal direction in one of the states LI and RI or makes a pitch motion control the cursor H51 in a vertical direction in one of the states UI and DI, the pointing direction (the operating direction UV1) of the control device 51 will be aligned with the cursor H51 and the cursor H51 will move with the motion of the control device 51. When the control device 51 makes a yaw motion in one of the states LO and RO or makes a pitch motion in one of the states UO and DO, the estimated direction FV1 varies outside the estimated direction range FR1 and the motion of the control device 51 causes the cursor H51 to stay on the perimeter 222V of the operation area 222 and will not cause the cursor H51 to move on the operation area 222. If the user wishes to cause the cursor H51 to resume the motion, the user may cause the control device 51 to resume being in one of the states LI, RI, UI and DI and cause the operating direction UV1 of the control device 51 to point to a position in the operation area 222; and under this condition, the cursor H51 will move with a further motion of the control device 51.

For instance, the direction range FR2 is a direction range outside the estimated direction range FR1; and the estimated direction range FR1 has the direction range perimeter FB1 and the direction perimeter range FBV adjacent to the direction range FR2. As shown in FIG. 6(a) and FIG. 6(b), when the estimated direction FV1 of the control device 51 is varied to approach the direction range perimeter FB1 and cross over the direction range perimeter FB1 from the direction range FR2 or when the control device 51 has one of a first condition, a second condition, a third condition and a fourth condition, the control device 51 starts a function which causes the cursor H51 to synchronously move with the control device 51, so that the cursor H51 on the screen 22 moves in response to a 3D space motion of the control device 51.

The first condition is that the control device 51 in the state LO is moved to cause the estimated direction FV1 of the control device 51 to approach the direction range perimeter FB1 and cause the control device 51 to enter the state LI. The second condition is that the control device 51 in the state RO is moved to cause the estimated direction FV1 of the control device 51 to approach the direction range perimeter FB1 and cause the control device 51 to enter the state RI. The third condition is that the control device 51 in the state UO is moved to cause the estimated direction FV1 of the control device 51 to approach the direction range perimeter FB1 and cause the control device 51 to enter the state UI. The fourth condition is that the control device 51 in the state DO is moved to cause the estimated direction FV1 of the control device 51 to approach the direction range perimeter FB1 and cause the control device 51 to enter the state DI.

The states LI and LO have a first boundary condition therebetween; the states RI and RO have a second boundary condition therebetween; the states UI and UO have a third boundary condition therebetween; and the states DI and DO have a fourth boundary condition therebetween; and there are a first specific state, a second specific state and a third specific state. The first specific state is the same as one of the states LI, RI, UI and DI, and has a specific condition the same as one of the first, the second, the third and the fourth boundary conditions. The second specific state is the same as one of the states LO, RO, UO and DO, and corresponds to the first specific state. The third specific state is the same as the first specific state. As shown in FIG. 6(a) and FIG. 6(b), in the third specific state, the estimated direction FV1 in a first specific orientation (or a first specific posture) of the control device 51 has a first specific estimated direction in the direction perimeter range FBV. The estimated direction FV1 is varied from the first specific estimated direction to cause the control device 51 to enter the second specific state. When the control device 51 enters the first specific state through the specific condition from the second specific state, the estimated direction FV1 of the current orientation (having a second specific orientation or a second specific posture) of the control device 51 has a second specific estimated direction. If the second specific estimated direction is different from the first specific estimated direction, the control device 51 uses the gyroscope 2121, the accelerometer 2122 and the electronic compass 2123 to obtain an estimated coordinate, corresponding to a position in the operation area 222, in the current orientation of the control device 51, and use an orientation comparison compensation program to compare the first and the second specific estimated directions for obtaining a difference between the first and the second specific estimated directions.

The control device 51 points to a variable point on the screen 22. Before the control device 51 causes the cursor H51 to further move on the screen 22, the control device 51 makes a coordinate compensation according to the difference, so that when the control device 51 with the second orientation different from the first specific orientation causes the variable point to enter the operation area 222, the motion start point of the cursor H51 on the screen 22 consistently corresponds to an orientation of the control device 51. When the control device 51 enters the first specific state from the second specific state to cause the variable point to vary in the operation area 222, the control device 51 causes the cursor H51 on the screen 22 to move with the motion of the control device 51.

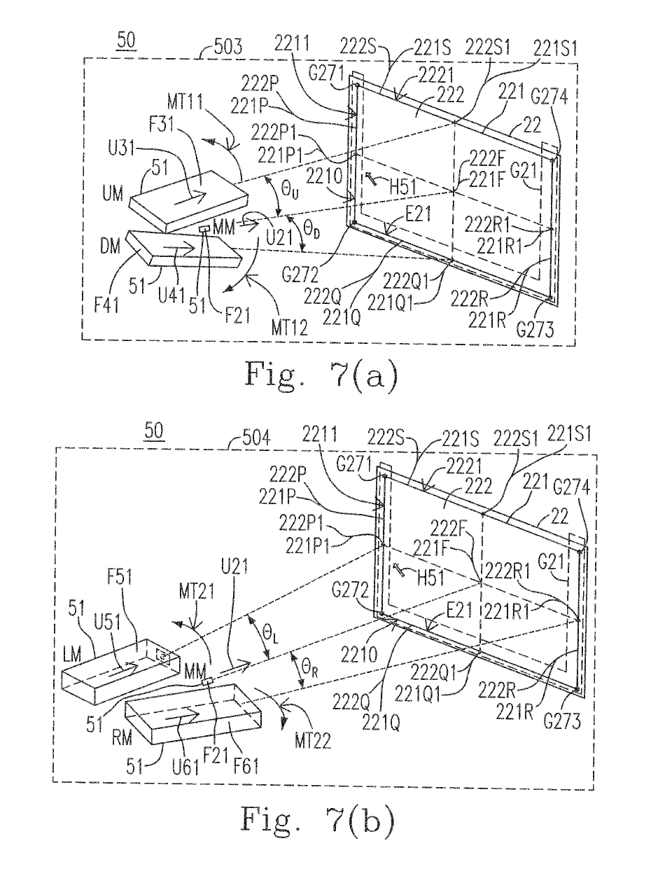

Please refer to FIG. 7(a) and FIG. 7(b), which are schematic diagrams showing a third configuration 503 and a fourth configuration 504 of the control system 50 according to the third embodiment of the present invention, respectively. The structures of the third configuration 503 and the fourth configuration 504 are similar to those of the first configuration 501 and the second configuration 502. The features of the third configuration 503 and the fourth configuration 504 are described as follows. In FIG. 7(a) and FIG. 7(b), the perimeter 2221 of the operation area 222 includes a property of a centroid 222F, the left boundary 222P, the lower boundary 222Q, the right boundary 222R and the upper boundary 222S, wherein the left boundary 222P, the lower boundary 222Q, the right boundary 222R and the upper boundary 222S have four specific positions 222P1, 222Q1, 222R1 and 222S1 (such as four mid-points), respectively.

The geometric reference 221 has a reference area 2210 corresponding to the estimated direction range FR1 for defining the operation area 222. For instance, the geometric reference 221 has the reference rectangle 2211. For instance, the centroid 221F, the left boundary 221P, the lower boundary 221Q, the right boundary 221R, the upper boundary 221S and the specific positions 221P1, 221Q1, 221R1 and 221S1 of the reference rectangle 2211 define the centroid 222F, the left boundary 222P, the lower boundary 222Q, the right boundary 222R, the upper boundary 222S and the specific positions 222P1, 222Q1, 222R1 and 222S1, respectively.

In FIG. 7(a), the control device 51 has a state MM in a time period. Then the control device 51 makes a pitch-upward motion MT and a pitch-downward motion MT12 form two states UM and DM in respective different time periods. In FIG. 7(b), the control device 51 makes a yaw-leftward motion MT21 and a yaw-rightward motion MT22 form two states UM and DM in respective different time periods.

As shown in FIG. 7(a), in the state MM, the control device 51 has a reference direction U21 and points to the centroid 222F. In the state UM, the control device 51 has a reference direction U31 and points to the specific position 222S1. In the state DM, the control device 51 has a reference direction U41 and points to the specific position 222Q1. As shown in FIG. 7(b), in the state LM, the control device 51 has a reference direction U51 and points to the specific position 222P1. In the state RM, the control device 51 has a reference direction U61 and points to the specific position 222R1.

The reference directions U21, U31, U41, U51 and U61 define the reference direction range FU1 corresponding to the geometric reference 221. The control device 51 senses the reference directions U21, U31, U41, U51 and U61 in the respective reference directions U21, U31, U41, U51 and U61 to generate the estimated directions F21, F31, F41, F51 and F61 respectively corresponding to the reference directions U21, U31, U41, U51 and U61, wherein the reference directions U21, U31, U41, U51 and U61 may be arranged in any order. The control device 51 uses the estimated directions F21, F31, F41, F51 and F61 to define the estimated direction range FR1 or the reference direction range FU1. For instance, the estimated direction range FR1 has the direction range parameter FR1P for defining the estimated direction range FR1. The direction range parameter FR1P includes a middle-reference estimated direction FR11, an upward-limit estimated direction FR12, a downward-limit estimated direction FR13, a leftward-limit estimated direction FR14 and a rightward-limit estimated direction FR15. The estimated directions F21, F31, F41, F51 and F61 define the middle-reference direction FR11, the upward-limit direction FR12, the downward-limit direction FR13, the leftward-limit direction FR14 and the rightward-limit estimated direction FR15, respectively.

For instance, the reference directions U21 and U31 have an angle θ_{U} therebetween; the reference directions U21 and U41 have an angle θ_{D} therebetween; the reference directions U21 and U51 have an angle θ_{L} therebetween; and the reference directions U21 and U61 have an angle θ_{R} therebetween. For instance, as shown in FIG. 7(a), when the control device 51 points to the upper boundary 222S of the operation area 222, the control device 51 pointing to the screen 22 has the reference direction U31 and the reference direction U31 and the normal line of the operation area 222 (or the reference direction U21) has the angle θ_{U} therebetween in relation to the normal line of the operation area 222 (or the reference direction U21). When the control device 51 points to the lower boundary 222Q of the operation area 222, the control device 51 pointing to the screen 22 has the reference direction U41 and the reference direction U41 and the normal line of the operation area 222 (or the reference direction U21) has the angle θ_{D} therebetween in relation to the normal line of the operation area 222 (or the reference direction U21). As shown in FIG. 7(b), when the control device 51 points to the left boundary 222P of the operation area 222, the control device 51 pointing to the screen 22 has the reference direction U51 and the reference direction U51 and the normal line of the operation area 222 (or the reference direction U21) has the angle θ_{L} therebetween in relation to the normal line of the operation area 222 (or the reference direction U21). When the control device 51 points to the right boundary 222R of the operation area 222, the control device 51 pointing to the screen 22 has the reference direction U61 and the reference direction U61 and the normal line of the operation area 222 (or the reference direction U21) has the angle θ_{R} therebetween in relation to the normal line of the operation area 222 (or the reference direction U21).

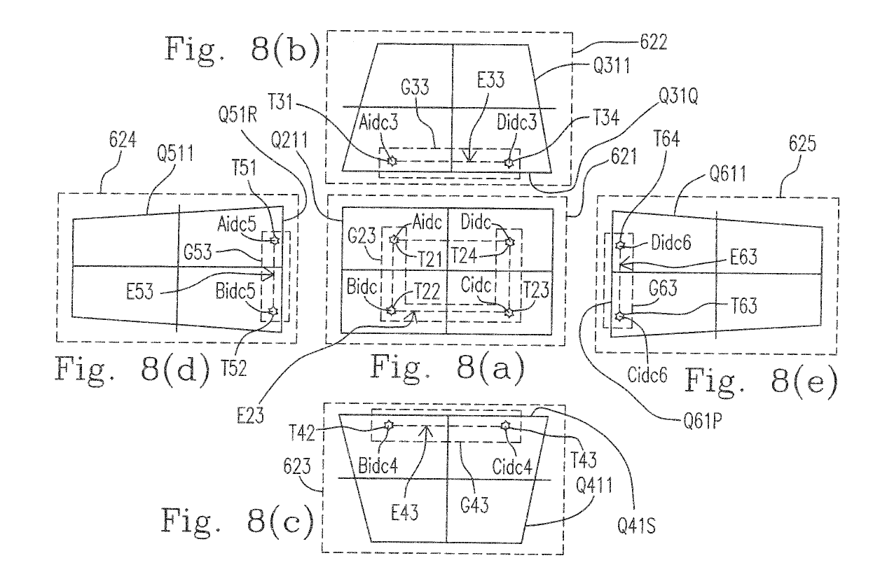

Please refer to FIG. 8(a), FIG. 8(b), FIG. 8(c), FIG. 8(d) and FIG. 8(e), which are schematic diagrams showing five pattern models 621, 622, 623, 624 and 625 of the control system 50 according to the third embodiment of the present invention, respectively. The control device 51 generates the signals S11, S13, S14, S15 and S16 in the respective reference directions U21, U31, U41, U51 and U61, wherein the signals S11, S13, S14, S15 and S16 represent the images Q21, Q31, Q41, Q51 and Q61, respectively. The images Q21, Q31, Q41, Q51 and Q61 include the patterns G22, G32, G42, G52 and G62, respectively, further include the geometric references Q211, Q311, Q411, Q511 and Q611, respectively, and further has reference areas, respectively.

The geometric references Q211, Q311, Q411, Q511 and Q611 define the reference areas of the images Q21, Q31, Q41, Q51 and Q61, respectively. The control device 51 generates the pattern models 621, 622, 623, 624 and 625 according to the respective images Q21, Q31, Q41, Q51 and Q61. The pattern models 621, 622, 623, 624 and 625 include patterns G23, G33, G43, G53 and G63, respectively, and further include the geometric references Q211, Q311, Q411, Q511 and Q611, respectively. The patterns G23, G33, G43, G53 and G63 are obtained from the pattern G21, wherein the pattern G21 has the characteristic rectangle E21 and the light spots G2171, G2172, G2173 and G2174 for defining the characteristic rectangle E21. For instance, each of the patterns G33, G43, G53 and G63 may be obtained according to the transformation parameter PM1.

As shown in FIG. 8(a), the pattern model 621 includes the geometric reference Q211 and the pattern G23. The pattern G23 includes a characteristic rectangle E23 and four light spots T21, T22, T23 and T24 for defining the characteristic rectangle E23. The four light spots G2171, G2172, G2173 and G2174 for defining the perimeter 2221 (having a characteristic rectangle) of the operation area 222 are converted into the light spots T21, T22, T23 and T24 in a middle place of the geometric reference Q211. The characteristic rectangle E23 includes four endpoints Aidc, Bidc, Cidc and Didc. The detailed relationship between the geometric reference Q211 and the pattern G23 is shown in FIG. 4(b). For instance, the characteristic rectangle E23 and the geometric reference Q211 have the geometric relationship R12 therebetween.

As shown in FIG. 8(b), the pattern model 622 includes the geometric reference Q311 and the pattern G33. The pattern G33 includes a characteristic line segment E33 and two light spots T31 and T34 for defining the characteristic line segment E33. The two light spots G2171 and G2174 for defining the upper boundary 222S of the operation area 222 are converted into the light spots T31 and T34 near a lower boundary Q31Q of the geometric reference Q311. The characteristic line segment E33 includes two endpoints Aidc3 and Didc3. For instance, the characteristic line segment E33 and the geometric reference Q311 have the geometric relationship R32 therebetween. For instance, the characteristic line segment E33 and the lower boundary Q31Q has a first distance therebetween; and the geometric relationship R32 includes that the characteristic line segment E33 on the geometric reference Q311 is parallel with the lower boundary Q31Q and the first distance is within a first specific distance range.

As shown in FIG. 8(c), the pattern model 623 includes the geometric reference Q411 and the pattern G43. The pattern G43 includes a characteristic line segment E43 and two light spots T42 and T43 for defining the characteristic line segment E43. The two light spots G2172 and G2173 for defining the lower boundary 222Q of the operation area 222 are converted into the light spots T42 and T43 near an upper boundary Q41S of the geometric reference Q411. The characteristic line segment E43 includes two endpoints Bidc4 and Cidc4. For instance, the characteristic line segment E43 and the geometric reference Q411 have the geometric relationship R42 therebetween. For instance, the characteristic line segment E43 and the upper boundary Q41S has a second distance therebetween; and the geometric relationship R42 includes that the characteristic line segment E43 on the geometric reference Q411 is parallel with the upper boundary Q41S and the second distance is within a second specific distance range.

As shown in FIG. 8(d), the pattern model 624 includes the geometric reference Q511 and the pattern G53. The pattern G53 includes a characteristic line segment E53 and two light spots T51 and T52 for defining the characteristic line segment E53. The two light spots G2171 and G2172 for defining the lower boundary 222P of the operation area 222 are converted into the light spots T51 and T52 near a right boundary Q51R of the geometric reference Q511. The characteristic line segment E53 includes two endpoints Aidc5 and Bidc5. For instance, the characteristic line segment E53 and the geometric reference Q511 have the geometric relationship R52 therebetween. For instance, the characteristic line segment E53 and the right boundary Q51R has a third distance therebetween; and the geometric relationship R52 includes that the characteristic line segment E53 on the geometric reference Q511 is parallel with the right boundary Q51R and the third distance is within a third specific distance range.

As shown in FIG. 8(e), the pattern model 625 includes the geometric reference Q611 and the pattern G63. The pattern G63 includes a characteristic line segment E63 and two light spots T63 and T64 for defining the characteristic line segment E63. The two light spots G2173 and G2174 for defining the right boundary 222R of the operation area 222 are converted into the light spots T63 and T64 near a left boundary Q61P of the geometric reference Q611. The characteristic line segment E63 includes two endpoints Cidc6 and Didc6. For instance, the characteristic line segment E63 and the geometric reference Q611 have the geometric relationship R62 therebetween. For instance, the characteristic line segment E63 and the left boundary Q61P has a fourth distance therebetween; and the geometric relationship R62 includes that the characteristic line segment E63 on the geometric reference Q611 is parallel with the left boundary Q61P and the fourth distance is within a fourth specific distance range.

For instance, under a specific condition, the control unit 214 uses the estimated directions F21, F31, F41, F51 and F61 to obtain the estimated direction range FR1 corresponding to the operation area 222 (or the geometric reference 221). The specific condition is that the control unit 214 obtains the estimated directions F21, F31, F41, F51 and F61 in the respective reference directions U21, U31, U41, U51 and U61 of the control device 51, and confirms a first status, a second status, a third status, a fourth status and a fifth status in the respective reference directions U21, U31, U41, U51 and U61. The first status is that the pattern G23 and the geometric reference Q211 have the geometric relationship R12 therebetween. The second status is that the pattern G33 and the geometric reference Q311 have the geometric relationship R32 therebetween. The third status is that the pattern G43 and the geometric reference Q411 have the geometric relationship R42 therebetween. The fourth status is that the pattern G53 and the geometric reference Q511 have the geometric relationship R52 therebetween. The fifth status is that the pattern G63 and the geometric reference Q611 have the geometric relationship R62 therebetween.

FIG. 7(a) and FIG. 8(a) show a first correspondence between the reference direction U21 of the orientation of the control device 51 and the centroid 222F of the operation area 222. FIG. 7(a) and FIG. 8(b) show a second correspondence between the reference direction U31 and the upper boundary 222S. FIG. 7(a) and FIG. 8(c) show a third correspondence between the reference direction U41 and the lower boundary 222Q. FIG. 7(b) and FIG. 8(d) show a fourth correspondence between the reference direction U51 and the left boundary 222P. FIG. 7(b) and FIG. 8(e) show a fifth correspondence between the reference direction U61 and the right boundary 222R. As shown in FIG. 7(a), in the state MM, the control device 51 senses the reference direction U21 to generate the estimated direction F21 for making a correspondence between the reference direction U21 and the pattern model 621. The estimated direction F21 is configured to express a middle-reference direction (or the reference direction U21, which is converted into the middle-reference estimated direction FR11).

As shown in FIG. 7(a), when an image obtained through the image-sensing unit 211 of the control device 51 by sensing the pattern G21 is standardized to form the pattern model 622 as shown in FIG. 8(b), the control device 51 is in the state UM and the reference direction U31 and the normal line of the operation area 222 (or the reference direction U21) has the angle θ_{U} therebetween in relation to the normal line of the operation area 222 (or the reference direction U21). For instance, the elevation angle θ_{U} is configured to represent an angle between the reference directions U31 and U21 when the upper boundary 222S of the operation area 222 corresponds to an upward-limit direction (or the reference direction U31, which is converted into the upward-limit estimated direction FR12).

As shown in FIG. 7(a), when an image obtained through the image-sensing unit 211 by sensing the pattern G21 is standardized to form the pattern model 623 as shown in FIG. 8(c), the control device 51 is in the state DM and the reference direction U41 and the normal line of the operation area 222 (or the reference direction U21) has the angle θ_{D} therebetween in relation to the normal line of the operation area 222 (or the reference direction U21). For instance, the depression angle θ_{D} is configured to represent an angle between the reference directions U41 and U21 when the lower boundary 222Q of the operation area 222 corresponds to a downward-limit direction (or the reference direction U41, which is converted into the downward-limit estimated direction FR13). Each of the two angles θ_{U} and θ_{D} may be measured by the accelerometer 2122.

Similarly, the reference direction of the orientation of the control device 51 may be a left yaw angle or a right yaw angle. As shown in FIG. 7(b), when an image obtained through the image-sensing unit 211 by sensing the pattern G21 is standardized to form the pattern model 624 as shown in FIG. 8(d), the control device 51 is in the state LM and the reference direction U51 and the normal line of the operation area 222 (or the reference direction U21) has the angle θ_{L} therebetween in relation to the normal line of the operation area 222 (or the reference direction U21). For instance, the left yaw angle θ_{L} is configured to represent an angle between the reference directions U51 and U21 when the left boundary 222P of the operation area 222 corresponds to a leftward-limit direction (or the reference direction U51, which is converted into the leftward-limit estimated direction FR14).

As shown in FIG. 7(b), when an image obtained through the image-sensing unit 211 by sensing the pattern G21 is standardized to form the pattern model 625 as shown in FIG. 8(e), the control device 51 is in the state RM and the reference direction U61 and the normal line of the operation area 222 (or the reference direction U21) has the angle θ_{R} therebetween in relation to the normal line of the operation area 222 (or the reference direction U21). For instance, the right yaw angle θ_{R} is configured to represent an angle between the reference directions U61 and U21 when the right boundary 222R of the operation area 222 corresponds to a rightward-limit direction (or the reference direction U61, which is converted into the rightward-limit estimated direction FR15). Each of the two angles θ_{L} and θ_{R} may be measured by the gyroscope 2121.

These angles θ_{U}, θ_{D}, θ_{L} and θ_{R} may be configured to define the abovementioned reference direction range. The control device 51 may senses these angles θ_{U}, θ_{D}, θ_{L} and θ_{R} to obtain the estimated direction range FR1 for the operation B5 of the screen 22 shown in FIG. 6(a) and FIG. 6(b). The control device 51 starts or stops to cause the cursor H51 to move with a motion of the control device 51 according to a relationship between the estimated direction FV1 and the estimated direction range FR1.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A control device for controlling a screen, the screen having a first geometric reference for an operation and a first pattern associated with the first geometric reference, the control device being configured to sequentially have a plurality of reference directions and an operating direction, the plurality of reference directions defining a reference direction range corresponding to the first geometric reference, and the operating direction and the reference direction range having a first relationship therebetween, the control device comprising:
a processing unit generating a plurality of patterns associated with the first pattern in the plurality of reference directions, respectively, estimating the reference direction range according to the plurality of reference directions and the plurality of patterns, and controlling the operation of the screen by estimating the first relationship.

2. A control device according to claim 1, wherein:
the processing unit senses the plurality of reference directions to generate a plurality of estimated directions in the plurality of reference directions, respectively, obtains an estimated direction range for estimating the reference direction range according to the plurality of estimated directions and the plurality of patterns, generates a first estimated direction by sensing the operating direction, obtains a second relationship between the first estimated direction and the estimated direction range for estimating the first relationship, and controls the operation of the screen according to the second relationship;
the processing unit further obtains a second geometric reference for defining the first geometric reference, and a correspondence relationship between the second geometric reference and the estimated direction range according to the plurality of estimated directions and the plurality of patterns for controlling the operation; and
the screen further has an operation area, the first geometric reference defines the operation area, and the operation area is a display area and has a perimeter area and a cursor displayed on the operation area.

3. A control device according to claim 2, wherein:
the operating direction is a variable reference direction, and the first estimated direction is a variable estimated direction;
the processing unit causes the cursor to stay on the perimeter area of the operation area when the first estimated direction varies outside the estimated direction range; and
the processing unit causes the cursor to move into the operation area according to the second relationship and the correspondence relationship when the first estimated direction enters the estimated direction range from an outside of the estimated direction range.

4. A control device according to claim 2, wherein:
the first geometric reference includes a first rectangle having a centroid, an upper boundary, a lower boundary, a left boundary and a right boundary, and the upper boundary, the lower boundary, the left boundary and the right boundary have a first specific position, a second specific position, a third specific position and a fourth specific position, respectively;
the plurality of reference directions includes a second reference direction, a third reference direction, a fourth reference direction, a fifth reference direction and a sixth reference direction respectively corresponding to the centroid, and the first, the second, the third and the fourth specific positions; and
the plurality of estimated directions includes a second estimated direction, a third estimated direction, a fourth estimated direction, a fifth estimated direction and a sixth estimated direction respectively corresponding to the second, the third, the fourth, the fifth and the sixth reference directions.

5. A control device according to claim 4, wherein:
the estimated direction range has a direction range parameter for defining the estimated direction range;
the direction range parameter includes a middle-reference estimated direction, an upward-limit estimated direction, a downward-limit estimated direction, a leftward-limit estimated direction and a rightward-limit estimated direction; and
the second, the third, the fourth, the fifth and the sixth estimated directions define the middle-reference, the upward-limit, the downward-limit, the leftward-limit and the rightward-limit estimated directions, respectively.

6. A control device according to claim 4, wherein:
the plurality of patterns includes a second pattern, a third pattern, a fourth pattern, a fifth pattern and a sixth pattern respectively corresponding to the second, the third, the fourth, the fifth and the sixth reference directions;
the processing unit further generates a plurality of first signals in the plurality of reference directions, respectively, wherein the plurality of first signals represent a plurality of first images, respectively, the plurality of first images includes the plurality of patterns, respectively, and further includes a plurality of geometric references, respectively; and
the plurality of geometric references includes a third geometric reference, a fourth geometric reference, a fifth geometric reference, a sixth geometric reference and a seventh geometric reference respectively corresponding to the second, the third, the fourth, the fifth and the sixth patterns.

7. A control device according to claim 6, wherein:
the processing unit further obtains a first geometric relationship between the second pattern and the third geometric reference, generates a transformation parameter according to the first geometric relationship, transforms the second pattern into a seventh pattern according to the transformation parameter, and obtains the second geometric reference according to the seventh pattern, wherein the seventh pattern and the third geometric reference have a second geometric relationship therebetween;
the processing unit transforms the third, the fourth, the fifth and the sixth patterns into an eighth pattern, a ninth pattern, a tenth pattern and an eleventh pattern respectively according to the transformation parameter and the fourth, the fifth, the sixth and the seventh geometric references, wherein the eighth pattern and the fourth geometric reference have a third geometric relationship therebetween, the ninth pattern and the fifth geometric reference have a fourth geometric relationship therebetween, the tenth pattern and the sixth geometric reference have a fifth geometric relationship therebetween, and the eleventh pattern and the seventh geometric reference have a sixth geometric relationship therebetween; and
the processing unit obtains the estimated direction range and the correspondence relationship according to the second geometric reference, the second, the third, the fourth, the fifth and the sixth estimated directions, and the second, the third, the fourth, the fifth and the sixth geometric relationships to cause the estimated direction range to correspond to the operation area.

8. A control device according to claim 7, having a first motion to cause the control device to sequentially point to the plurality of reference directions and the operating direction, and the processing unit comprises:
an image-sensing unit sequentially sensing the first pattern in the plurality of respective reference directions to generate a second signal including the plurality of first signals, wherein the plurality of first signals further represent a plurality of second images, respectively;
a motion-sensing unit converting the first motion into a third signal;
a control unit coupled to the image-sensing unit and the motion-sensing unit, obtaining the plurality of first images, the transformation parameter, the second geometric reference, the plurality of estimated directions, the first, the second, the third, the fourth, the fifth and the sixth geometric relationships, the estimated direction range, the first estimated direction, the second relationship and the correspondence relationship according to the second and the third signals, and controlling the operation according to the second relationship and the correspondence relationship; and
a communication interface unit coupled to the control unit controlling the operation through the communication interface unit.

9. A control device according to claim 8, wherein:
the control unit causes the cursor to move within the operation area when the operating direction varies to cause the first estimated direction to vary within the estimated direction range; and
the control unit causes the cursor to stay on the perimeter area of the operation area when the operating direction varies to cause the first estimated direction to vary outside the estimated direction range.

10. A control device according to claim 8, wherein:
the control unit further obtains a first direction range being a direction range outside the estimated direction range;
the estimated direction range further has a direction perimeter range adjacent to the first direction range, wherein the direction perimeter range and the first direction range has a direction range perimeter therebetween;
the direction perimeter range includes a seventh estimated direction and an eighth estimated direction different from the seventh estimated direction; and
the first direction range includes a ninth estimated direction adjacent to the direction perimeter range.

11. A control device according to claim 10, wherein:
the control unit starts a function of a cursor synchronization motion when the operating direction varies to cause the first estimated direction to vary from the ninth estimated direction to cross over the direction range perimeter; and
the control unit performs a coordinate compensation process when the operating direction varies to cause the first estimated direction to enter the first direction range from the seventh estimated direction and then cause the first estimated direction to reach the eighth estimated direction from the first direction range.

12. A control device according to claim 8, wherein the processing unit further has an image pick-up calculation program and uses the image pick-up calculation program to process a specific image corresponding to the second reference direction in the plurality of second images so as to cause the second pattern to have a characteristic rectangle.

13. A method for controlling a screen having a first geometric reference for an operation, the method comprising steps of:
displaying a first pattern associated with the first geometric reference on the screen;
providing a plurality of reference directions, wherein the plurality of reference directions define a reference direction range corresponding to the first geometric reference;
generating a plurality of patterns associated with the first pattern in the plurality of reference directions, respectively; and
estimating the reference direction range according to the plurality of reference directions and the plurality of patterns for controlling the operation of the screen.

14. A method according to claim 13, further comprising steps of:
providing a control device, wherein the control device is configured to sequentially have the plurality of reference directions;
sensing the plurality of reference directions to generate a plurality of estimated directions in the plurality of reference directions, respectively;
obtaining an estimated direction range for estimating the reference direction range, a second geometric reference for defining the first geometric reference, and a correspondence relationship between the second geometric reference and the estimated direction range according to the plurality of estimated directions and the plurality of patterns;
causing the control device to has an operating direction, wherein the operating direction and the reference direction range have a first relationship therebetween;
generating a first estimated direction by sensing the operating direction, wherein the first estimated direction and the estimated direction range have a second relationship therebetween for estimating the first relationship;
obtaining the second relationship; and
controlling the operation according to the second relationship.

15. A method according to claim 14, wherein the screen further has an operation area, the first geometric reference defines the operation area, the operation area is a display area and has a perimeter area and a cursor displayed on the operation area, the operating direction is a variable reference direction, the first estimated direction is a variable estimated direction, and the method further comprises steps of:
causing the cursor to stay on the perimeter area of the operation area when the first estimated direction varies outside the estimated direction range; and
causing the cursor to move into the operation area according to the second relationship and the correspondence relationship when the first estimated direction enters the estimated direction range from an outside of the estimated direction range.

16. A method according to claim 14, further comprising steps of:
obtaining a first direction range being a direction range outside the estimated direction range, wherein the estimated direction range has a direction perimeter range adjacent to the first direction range, the direction perimeter range and the first direction range has a direction range perimeter therebetween, the direction perimeter range includes a second estimated direction and a third estimated direction different from the second estimated direction, and the first direction range includes a fourth estimated direction adjacent to the direction perimeter range;
starting a function of a cursor synchronization motion when the operating direction varies to cause the first estimated direction to vary from the fourth estimated direction to cross over the direction range perimeter; and
performing a coordinate compensation process when the operating direction varies to cause the first estimated direction to enter the first direction range from the second estimated direction and then cause the first estimated direction to reach the third estimated direction from the first direction range.

17. A method according to claim 14, wherein the first geometric reference has a first rectangle, the plurality of reference directions includes a specific reference direction, the plurality of patterns includes a specific pattern corresponding to the specific reference direction, and the method further comprises steps of:
obtaining a specific signal associated with the first pattern from the screen in the specific reference direction, wherein the specific signal represents a specific image;
providing an image pick-up calculation program; and
using the image pick-up calculation program to process the specific image so as to cause the specific pattern to have a characteristic rectangle.

18. A method according to claim 14, wherein:
the first geometric reference includes a first rectangle having a centroid, an upper boundary, a lower boundary, a left boundary and a right boundary, and the upper boundary, the lower boundary, the left boundary and the right boundary have a first specific position, a second specific position, a third specific position and a fourth specific position, respectively;
the plurality of reference directions includes a second reference direction, a third reference direction, a fourth reference direction, a fifth reference direction and a sixth reference direction respectively corresponding to the centroid, and the first, the second, the third and the fourth specific positions;
the plurality of estimated directions includes a second estimated direction, a third estimated direction, a fourth estimated direction, a fifth estimated direction and a sixth estimated direction respectively corresponding to the second, the third, the fourth, the fifth and the sixth reference directions;
the plurality of patterns includes a second pattern, a third pattern, a fourth pattern, a fifth pattern and a sixth pattern respectively corresponding to the second, the third, the fourth, the fifth and the sixth reference directions; and
the method further comprises steps of:
generating a plurality of first signals in the plurality of reference directions, respectively, wherein:
the plurality of first signals represent a plurality of first images, respectively,
the plurality of first images includes the plurality of patterns, respectively, and further includes a plurality of geometric references, respectively, and
the plurality of geometric references includes a third geometric reference, a fourth geometric reference, a fifth geometric reference, a sixth geometric reference and a seventh geometric reference respectively corresponding to the second, the third, the fourth, the fifth and the sixth patterns;
obtaining a first geometric relationship between the second pattern and the third geometric reference;
generating a transformation parameter according to the first geometric relationship;
transforming the second pattern into a seventh pattern according to the transformation parameter, wherein the seventh pattern and the third geometric reference have a second geometric relationship therebetween;
obtaining the second geometric reference according to the seventh pattern; and
transforming the third, the fourth, the fifth and the sixth patterns into an eighth pattern, a ninth pattern, a tenth pattern and an eleventh pattern respectively according to the transformation parameter, the fourth, the fifth, the sixth and the seventh geometric references, wherein:
the eighth pattern and the fourth geometric reference have a third geometric relationship therebetween;
the ninth pattern and the fifth geometric reference have a fourth geometric relationship therebetween;
the tenth pattern and the sixth geometric reference have a fifth geometric relationship therebetween;
the eleventh pattern and the seventh geometric reference have a sixth geometric relationship therebetween; and
the estimated direction range and the correspondence relationship are obtained further according to the second geometric reference and the second, the third, the fourth, the fifth and the sixth geometric relationships to cause the estimated direction range to correspond to the operation area.

19. A control device for controlling a screen, the screen having a first geometric reference for an operation and a first pattern associated with the first geometric reference, the control device being configured to have a plurality of reference directions, and the plurality of reference directions defining a reference direction range, the control device comprising:
a processing unit generating a plurality of patterns associated with the first pattern in the plurality of reference directions, respectively, and estimating the reference direction range according to the plurality of reference directions and the plurality of patterns for controlling the operation of the screen.

20. A control device according to claim 19, wherein:
the control device sequentially has the plurality of reference directions;
the reference direction range corresponds to the first geometric reference;
the control device is further configured to have an operating direction, wherein the operating direction and the reference direction range have a first relationship therebetween;
the processing unit senses the plurality of reference directions to generate a plurality of estimated directions in the plurality of reference directions, respectively, obtains an estimated direction range estimating the reference direction range according to the plurality of estimated directions and the plurality of patterns, generates a first estimated direction by sensing the operating direction, obtains a second relationship between the first estimated direction and the estimated direction range for estimating the first relationship, and controls the operation of the screen according to the second relationship; and
the processing unit further obtains a second geometric reference for defining the first geometric reference, and a correspondence relationship between the second geometric reference and the estimated direction range according to the plurality of estimated directions and the plurality of patterns, and controls the operation of the screen according to the correspondence relationship.
